(19) United States
(12) Patent Application Publication
(10) Pub. No.: US 2011/0276760 A1
(43) Pub. Date: Nov. 10, 2011

(54) NON-COMMITTING STORE INSTRUCTIONS

(76) Inventor: Yuan C. Chou, Los Gatos, CA (US)

(21) Appl. No.: 12/775,336

(22) Filed: May 6, 2010

(51) Int. Cl. G06F 9/30; G06F 12/08; G06F 12/00

(52) U.S. Cl. 711/118; 712/225; 711/160; 711/154; 712/E09.016; 711/E12.001; 711/E12.017

(57) ABSTRACT

Techniques relating to a processor that supports a non-committing store instruction that is executable during a scouting thread to provide data to a subsequently executed load instruction. The processor may include a memory access unit configured to perform an instance of the non-committing store instruction by storing a value in an entry of a store buffer without committing the instance of the non-committing store instruction. In response to subsequently receiving an instance of a load instruction of the scouting thread that specifies a load from the memory address, the memory access unit is configured to perform the instance of the load instruction by retrieving the value. The memory access unit may retrieve the value from the store buffer or from a cache of the processor.

### BACKGROUND

1. Technical Field

This disclosure relates to computer processors, and more specifically to processors that are configured to execute in a scouting mode.

2. Description of the Related Art

In executing a computer program, program order is generally followed in order to ensure correct results. Thus, when a first instruction is followed by a second instruction that depends on the first instruction's result, the execution of the second instruction is not completed until the first instruction's result becomes available. Sometimes a result will be available almost immediately. Other times, a result may take hundreds of processor cycles to become available—for example, in the case of a memory load that misses a data cache (e.g., an L1 cache) and must retrieve the desired data from elsewhere in the memory hierarchy (e.g., an L2 cache, main memory, etc.). One option in response to a lengthy delay in obtaining results (e.g., a memory cache miss) is to stall. Other options may include executing instructions speculatively or in a “scouting” thread in which data is prefetched for a main thread. In this manner, the cost of servicing multiple cache requests can thus be amortized.

### SUMMARY

Techniques and structures are disclosed herein that allow a processor to improve the effectiveness of scouting. In one embodiment, a processor is disclosed that includes a memory access unit configured to receive memory access instructions and initiate memory access operations specified by the received instructions. The memory access unit is configured to receive an instance of a non-committing store instruction within a scouting thread of the processor, where the non-committing store instruction specifies a value and a memory address to which the value is to be stored. The memory access unit is configured to perform the instance of the non-committing store instruction by storing the value in an entry of a store buffer without committing the instance of the non-committing store instruction, where the store buffer includes a plurality of entries. The memory access unit, in response to receiving, within the scouting thread, an instance of a load instruction that specifies a load from the memory address, is configured to perform the instance of the load instruction by retrieving the value. In one embodiment, the memory access unit, in response to receiving the instance of the load instruction, is configured to perform the load instruction by retrieving the value from the store buffer. In some embodiments, the processor includes a cache, where the memory access unit, in response to receiving the instance of the load instruction, is configured to perform the load instruction by retrieving the value from a cache entry of the cache.

In another embodiment, a method is disclosed that includes a processor executing, within a scouting thread, an instance of a non-committing store instruction, where the non-committing store instruction specifies a value and a memory address to which the value is to be stored. Executing the instance of the non-committing store instruction includes storing the value in an entry of a store buffer without committing the non-committing store instruction. The method includes the processor subsequently executing an instance of a load instruction of the scouting thread, where the load instruction specifies a load from the memory address, where executing the instance of the load instruction includes returning the value as a result of executing the instance of the load instruction.

In yet another embodiment, a computer-readable storage medium is disclosed having program instructions stored thereon that are executable by a processor having a memory access unit. The program instructions include an instance of a non-committing store instruction that specifies a first value and a first memory address to which the first value is to be stored. The instance of the non-committing store instruction is executable by the processor within a scouting thread to cause the memory access unit to store the first value in a store buffer of the memory access unit without updating an architectural state of the processor. The program instructions further include an instance of a load instruction that specifies a load from the first memory address, where the instance of the load instruction is executable by the process to cause the memory access unit to retrieve the first value.

### BRIEF DESCRIPTION OF THE DRAWINGS

FIG. 1 is a block diagram illustrating one embodiment of an exemplary processor.

FIG. 2 is a block diagram illustrating one embodiment of an exemplary processor core.

FIGS. 3A and 3B are block diagrams illustrating embodiments of a memory access unit configured to perform a non-committing store instruction.

FIG. 4 is a block diagram illustrating one embodiment of a store buffer.

FIGS. 5A and 3B are block diagrams illustrating other embodiments of a memory access unit configured to perform a non-committing store instruction.

FIG. 6 is a block diagram illustrating one embodiment of a data cache.

FIG. 7 is a flow diagram illustrating one embodiment of a method for executing an instance of a non-committing store instruction.

FIG. 8 is a flow diagram illustrating another embodiment of a method for executing an instance of a non-committing store instruction.

FIG. 9 is a flow diagram illustrating one embodiment of a method performed by a processor that includes a memory access unit.

FIG. 10 is a block diagram illustrating one embodiment of an exemplary system.

FIG. 11 is a block diagram illustrating one embodiment of an exemplary computer-readable storage medium.

### DETAILED DESCRIPTION

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “An apparatus comprising one or more processor units . . . ” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, sixth paragraph, for that unit/circuit/component.

“Execute.” This term has its ordinary and accepted meaning in the art, and includes all actions that may be performed by a processor to effectuate the completion of the instruction, including fetch, decode, issue, as well as actually computing the result of the instruction. When a functional unit is described herein as “executing” a particular instruction, this term refers to computing a result of the particular instruction (e.g., computing the sum of the contents of two registers).

“Thread.” As used herein, this term refers broadly to a set of instructions within a program that is executable by a processor. The term “thread” is thus used herein to indicate a group of instructions generally (e.g., a sequence of instructions), and is not limited for example, to a group of instructions executing on a processor as a result of a “fork” or other similar operation. Instructions described herein as being “within” a thread are a part of the set of instructions for a thread.

“Scouting.” This term has its ordinary and accepted meaning in the art, and includes executing instructions without committing their results in order to cause the prefetching of data for instructions that would otherwise result in a cache miss.

“Scouting thread.” This term has its ordinary and accepted meaning in the art, and includes a thread that includes instructions that are executed to perform scouting (i.e., in a scouting mode).

“Commit.” This term has its ordinary and accepted meaning in the art, and includes causing the results of a performed instruction to update architectural state.

“Non-committing store instruction.” As used herein, this term refers to a store instruction that is not committed by a processor upon execution.

“Committing store instruction.” As used herein, this term refers to a store instruction that is committed by a processor upon execution (i.e., updates the architectural state of the processor).

### Introduction

As noted above, executing instructions speculatively is one alternative to stalling for a result to become available. In speculative execution, instructions may be executed in a different order than defined by the program (i.e., executed out of order), where the results of some executed instructions may not be used. For example, a processor may begin fetching and executing instructions that are dependent upon a branch instruction based on a predicted outcome of that instruction. If, upon execution of that branch instruction, the processor determines that it mispredicted the outcome, the processor will not use the results of those dependent instructions. As another example, if a thread includes a load instruction that has caused a cache miss, the processor may execute instructions that come after the load instruction in program order if those instructions are not dependent on the load instruction. The processor may then execute the load instruction once the needed data has been retrieved from memory (i.e., the cache request has been serviced).

When speculative execution is not performed or is not supported, scouting is another alternative. As noted above, a processor may implement scouting in order to minimize the penalty incurred by multiple cache misses. Consider a situation in which a first memory load instruction of a thread misses in the cache. The data for the miss comes back after a relatively long delay. Upon resuming execution, a second instruction also causes a cache miss. By scouting, the processor can execute a scouting thread that causes the servicing of the cache miss of the second instruction to have already occurred at the time the cache miss of the first instruction is being serviced, allowing the processor to service multiple cache misses with a shorter delay than servicing each miss in sequence (i.e., taking the full cache miss penalty for each miss). Scouting thus involves the processor attempting to circumvent or reduce future stalls (e.g., those caused by future memory load instructions).

As an example, consider the following instruction sequence:
I201 LOAD [Address1], Reg1
I202 ADD Reg1, Reg2, Reg3
I203 LOAD [Address2], Reg2
I204 ADD Reg5, Reg6, Reg7
   The first instruction (I201) is an instruction to load a value from memory into a register Reg1. The next instruction in program order, I202, uses Reg1 as an operand and cannot be properly completed until a value for Reg1 becomes available. If I201 misses the cache, a delay might ensue while data is accessed. After this delay, and when Reg1 becomes available, I202 can be executed. But the next instruction I203 may also miss the cache, immediately causing another lengthy stall.

In a processor supporting scouting, upon the processor detecting that I201 has a caused a cache miss, the execution of I203 (and other subsequent instructions) may be performed to cause data to be prefetched from memory into the cache. Accordingly, instead of simply stalling until I201's results are available, the processor can proceed to determine if the memory value for Address2 (used by I203) is present in the cache. If the value is not present, the processor can cause the memory subsystem to begin fetching the Address2 value from memory at the same time that Address1 value is also being fetched. The delays caused by I201 and I203 will thus overlap instead of being sequential, which can lower the overall total delay experienced during program execution.

Instructions executed during scouting are not committed, and thus do not update architectural state. Previous processors implementing scouting have executed only certain instructions from the main thread—namely, load instructions or instructions that compute memory addresses for load instructions. In these previous processors, then, certain instructions are not executed during scouting. Store instructions are one type of instruction that are not executed during scouting performed by these previous processors because executing them will cause architectural state to be updated.

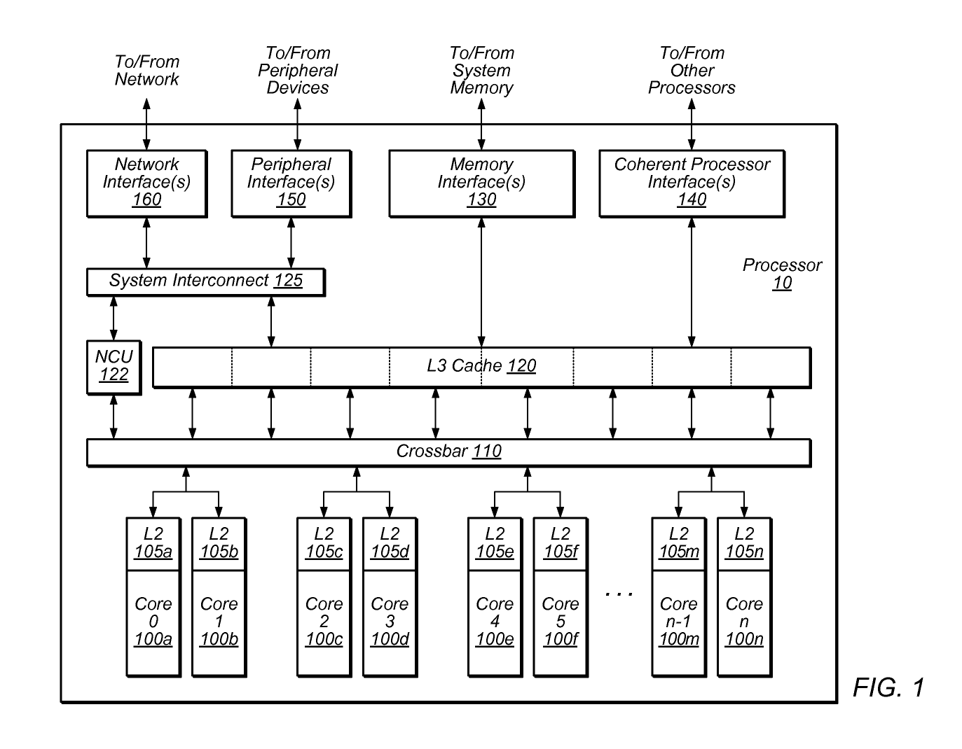

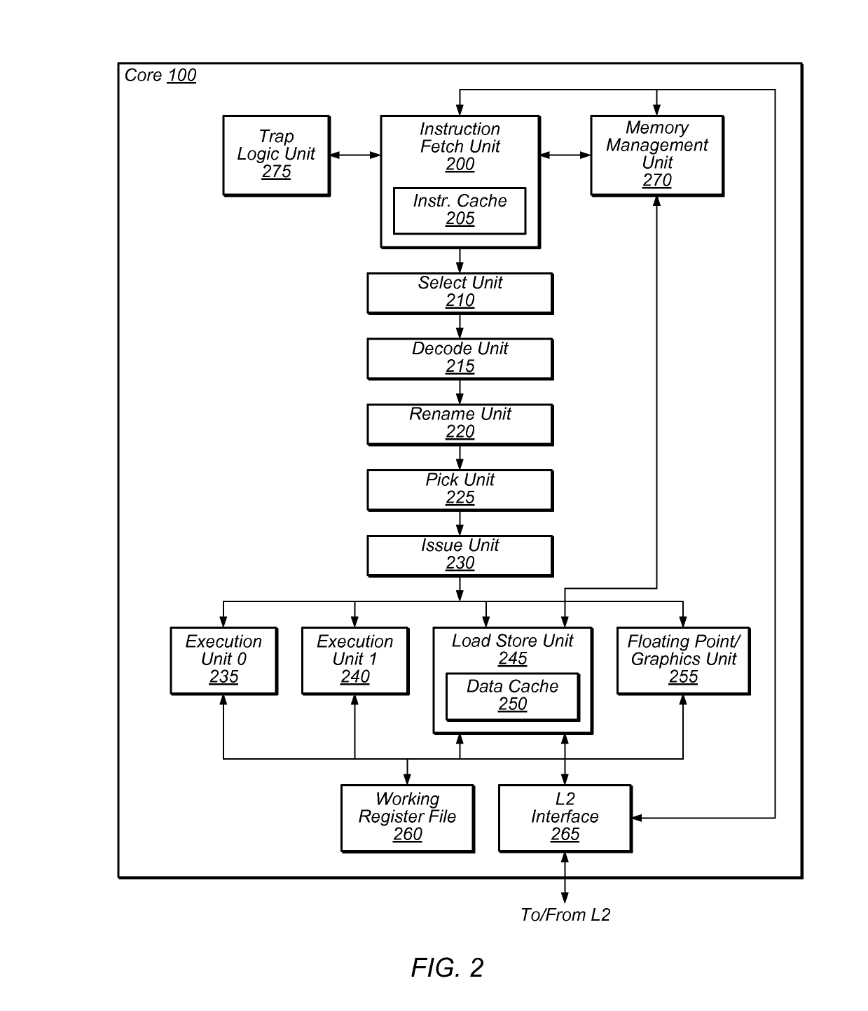

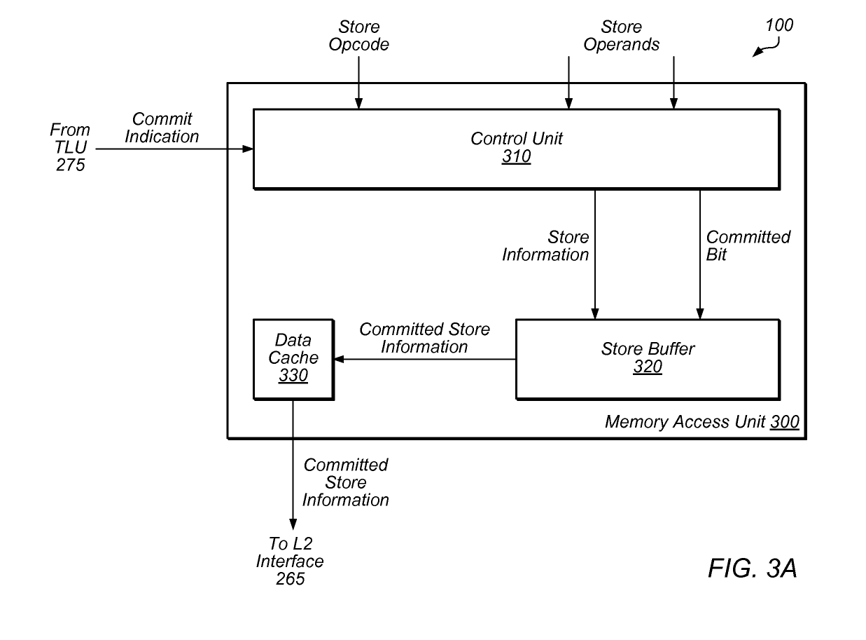

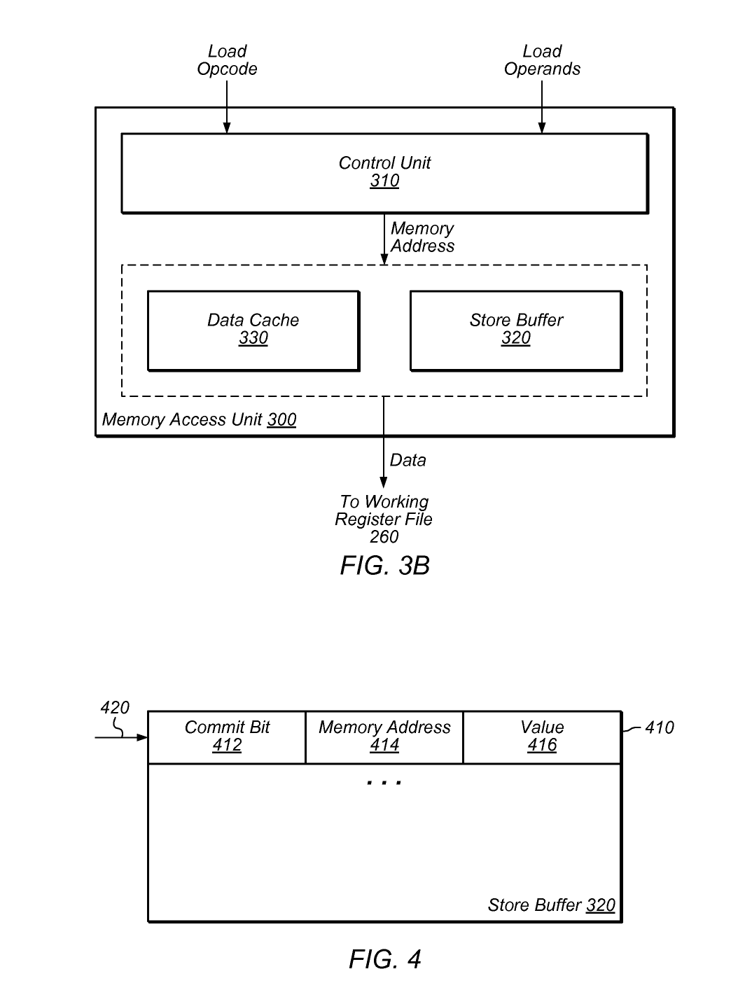

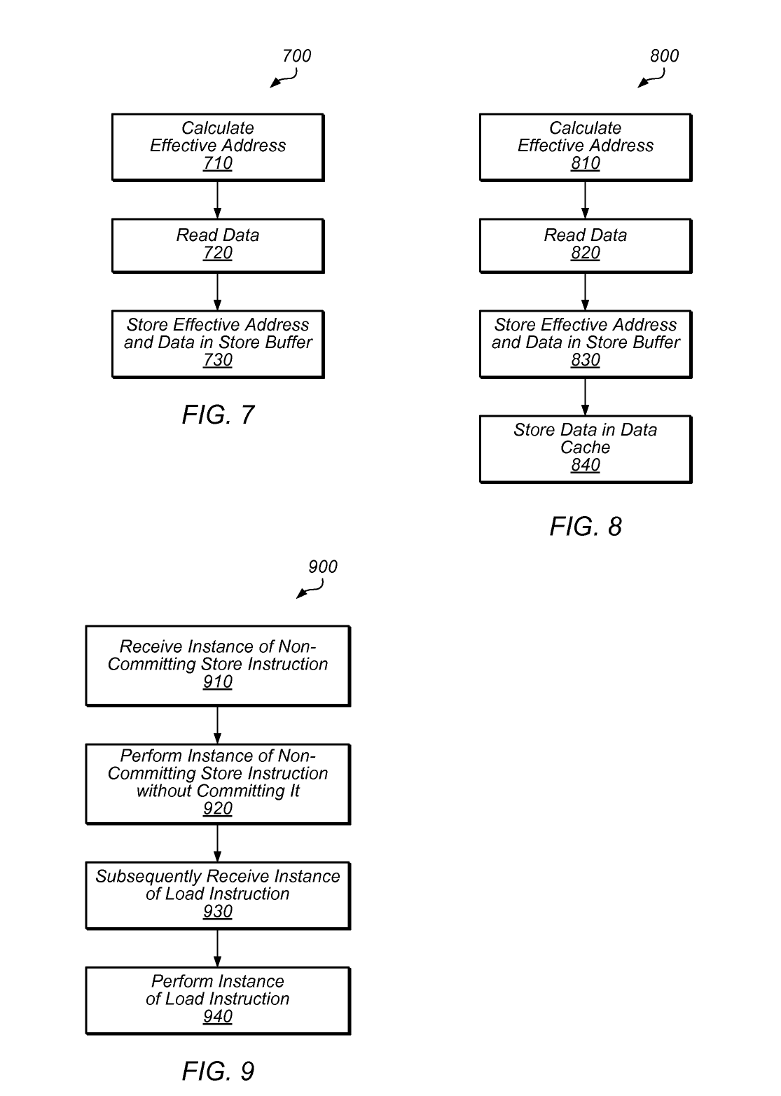

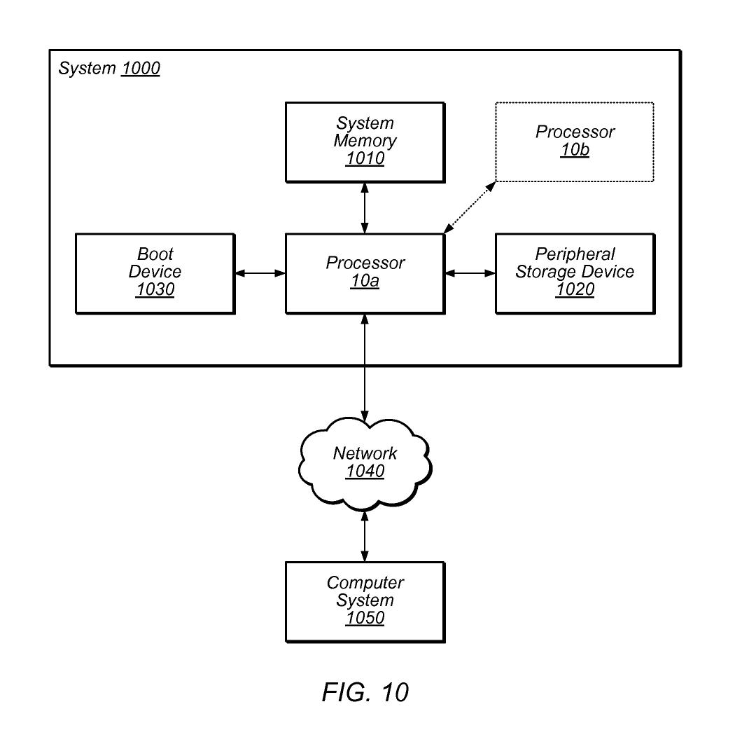

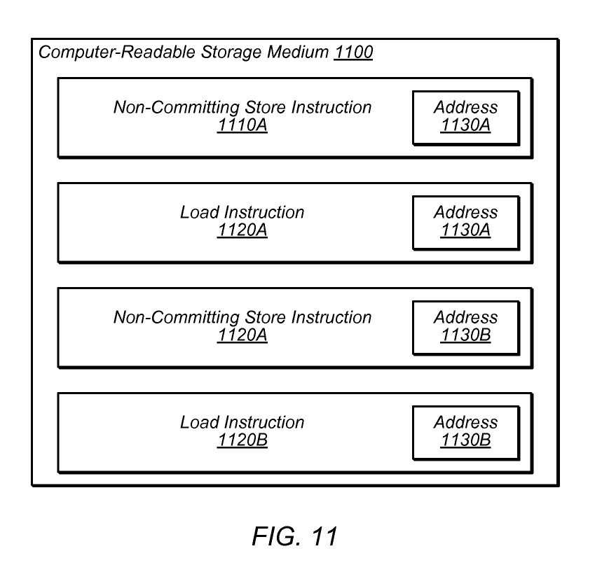

The present disclosure recognizes that eliminating store instructions from being performed during scouting may cause subsequent load instructions with matching memory addresses to receive incorrect data. These inaccuracies may in turn cause the scouting thread to execute inaccurate prefetches, thereby limiting the effectiveness of scouting. The present disclosure describes various embodiments of a processor that supports a non-committing store instruction that is executable during scouting to provide data to a subsequently executed load instruction. FIGS. 1 and 2 present an overview of an exemplary multithreaded processor. FIGS. 3-6 present embodiments of a processor core that includes structures configured to support execution of a non-committing store instruction. FIGS. 7-9 present embodiments of methods that may be performed by such a processor. FIG. 10 presents an overview of a computer system in which such a processor may be used. FIG. 11 presents a computer-readable storage medium storing one or more instances of the non-committing store instruction.

### General Overview of a Multithreaded Processor

Turning now to FIG. 1, a block diagram illustrating one embodiment of a processor 10 is shown. In certain embodiments, processor 10 may be multithreaded. In the illustrated embodiment, processor 10 includes a number of processor cores 100a-n, which are also designated “core 0” though “core n.” As used herein, the term processor may refer to an apparatus having a single processor core or an apparatus that includes two or more processor cores. Various embodiments of processor 10 may include varying numbers of cores 100, such as 8, 16, or any other suitable number. Each of cores 100 is coupled to a corresponding L2 cache 105a-n, which in turn couple to L3 cache 120 via a crossbar 110. Cores 100a-n and L2 caches 105a-n may be generically referred to, either collectively or individually, as core(s) 100 and L2 cache(s) 105, respectively.

Via crossbar 110 and L3 cache 120, cores 100 may be coupled to a variety of devices that may be located externally to processor 10. In the illustrated embodiment, one or more memory interface(s) 130 may be configured to couple to one or more banks of system memory (not shown). One or more coherent processor interface(s) 140 may be configured to couple processor 10 to other processors (e.g., in a multiprocessor environment employing multiple units of processor 10). Additionally, system interconnect 125 couples cores 100 to one or more peripheral interface(s) 150 and network interface(s) 160. As described in greater detail below, these interfaces may be configured to couple processor 10 to various peripheral devices and networks.

Cores 100 may be configured to execute instructions and to process data according to a particular instruction set architecture (ISA). In one embodiment, cores 100 may be configured to implement a version of the SPARC® ISA, such as SPARC® V9, UltraSPARC Architecture 2005, UltraSPARC Architecture 2007, or UltraSPARC Architecture 2009, for example. However, in other embodiments it is contemplated that any desired ISA may be employed, such as x86 (32-bit or 64-bit versions), PowerPC® or MIPS®, for example.

In the illustrated embodiment, each of cores 100 may be configured to operate independently of the others, such that all cores 100 may execute in parallel (i.e., concurrently). Additionally, as described below in conjunction with the descriptions of FIG. 2, in some embodiments, each of cores 100 may be configured to execute multiple threads concurrently, where a given thread may include a set of instructions that may execute independently of instructions from another thread. (For example, an individual software process, such as an application, may consist of one or more threads that may be scheduled for execution by an operating system.) Such a core 100 may also be referred to as a multithreaded (MT) core. In one embodiment, each of cores 100 may be configured to concurrently execute instructions from a variable number of threads, up to eight concurrently-executing threads. In a 16-core implementation, processor 10 could thus concurrently execute up to 128 threads. However, in other embodiments it is contemplated that other numbers of cores 100 may be provided, and that cores 100 may concurrently process different numbers of threads.

Additionally, as described in greater detail below, in some embodiments, each of cores 100 may be configured to execute certain instructions out of program order, which may also be referred to herein as out-of-order execution, or simply OOO. As an example of out-of-order execution, for a particular thread, there may be instructions that are subsequent in program order to a given instruction yet do not depend on the given instruction. If execution of the given instruction is delayed for some reason (e.g., owing to a cache miss), the later instructions may execute before the given instruction completes, which may improve overall performance of the executing thread.

As shown in FIG. 1, in one embodiment, each core 100 may have a dedicated corresponding L2 cache 105. In one embodiment, L2 cache 105 may be configured as a set-associative, write-back cache that is fully inclusive of first-level cache state (e.g., instruction and data caches within core 100). To maintain coherence with first-level caches, embodiments of L2 cache 105 may implement a reverse directory that maintains a virtual copy of the first-level cache tags. L2 cache 105 may implement a coherence protocol (e.g., the MESI protocol) to maintain coherence with other caches within processor 10. In one embodiment, L2 cache 105 may enforce a Total Store Ordering (TSO) model of execution in which all store instructions from the same thread must complete in program order.

In various embodiments, L2 cache 105 may include a variety of structures configured to support cache functionality and performance. For example, L2 cache 105 may include a miss buffer configured to store requests that miss the L2, a fill buffer configured to temporarily store data returning from L3 cache 120, a write-back buffer configured to temporarily store dirty evicted data and snoop copyback data, and/or a snoop buffer configured to store snoop requests received from L3 cache 120. In one embodiment, L2 cache 105 may implement a history-based prefetcher that may attempt to analyze L2 miss behavior and correspondingly generate prefetch requests to L3 cache 120.

Crossbar 110 may be configured to manage data flow between L2 caches 105 and the shared L3 cache 120. In one embodiment, crossbar 110 may include logic (such as multiplexers or a switch fabric, for example) that allows any L2 cache 105 to access any bank of L3 cache 120, and that conversely allows data to be returned from any L3 bank to any L2 cache 105. That is, crossbar 110 may be configured as an M-to-N crossbar that allows for generalized point-to-point communication. However, in other embodiments, other interconnection schemes may be employed between L2 caches 105 and L3 cache 120. For example, a mesh, ring, or other suitable topology may be utilized.

Crossbar 110 may be configured to concurrently process data requests from L2 caches 105 to L3 cache 120 as well as data responses from L3 cache 120 to L2 caches 105. In some embodiments, crossbar 110 may include logic to queue data requests and/or responses, such that requests and responses may not block other activity while waiting for service. Additionally, in one embodiment crossbar 110 may be configured to arbitrate conflicts that may occur when multiple L2 caches 105 attempt to access a single bank of L3 cache 120, or vice versa.

L3 cache 120 may be configured to cache instructions and data for use by cores 100. In the illustrated embodiment, L3 cache 120 may be organized into eight separately addressable banks that may each be independently accessed, such that in the absence of conflicts, each bank may concurrently return data to a respective L2 cache 105. In some embodiments, each individual bank may be implemented using set-associative or direct-mapped techniques. For example, in one embodiment, L3 cache 120 may be an 8 megabyte (MB) cache, where each 1 MB bank is 16-way set associative with a 64-byte line size. L3 cache 120 may be implemented in some embodiments as a write-back cache in which written (dirty) data may not be written to system memory until a corresponding cache line is evicted. However, it is contemplated that in other embodiments, L3 cache 120 may be configured in any suitable fashion. For example, L3 cache 120 may be implemented with more or fewer banks, or in a scheme that does not employ independently-accessible banks; it may employ other bank sizes or cache geometries (e.g., different line sizes or degrees of set associativity); it may employ write through instead of write-back behavior; and it may or may not allocate on a write miss. Other variations of L3 cache 120 configuration are possible and contemplated.

In some embodiments, L3 cache 120 may implement queues for requests arriving from and results to be sent to crossbar 110. Additionally, in some embodiments L3 cache 120 may implement a fill buffer configured to store fill data arriving from memory interface 130, a write-back buffer configured to store dirty evicted data to be written to memory, and/or a miss buffer configured to store L3 cache accesses that cannot be processed as simple cache hits (e.g., L3 cache misses, cache accesses matching older misses, accesses such as atomic operations that may require multiple cache accesses, etc.). L3 cache 120 may variously be implemented as single-ported or multiported (i.e., capable of processing multiple concurrent read and/or write accesses). In either case, L3 cache 120 may implement arbitration logic to prioritize cache access among various cache read and write requestors.

Not all external accesses from cores 100 necessarily proceed through L3 cache 120. In the illustrated embodiment, non-cacheable unit (NCU) 122 may be configured to process requests from cores 100 for non-cacheable data, such as data from I/O devices as described below with respect to peripheral interface(s) 150 and network interface(s) 160.

Memory interface 130 may be configured to manage the transfer of data between L3 cache 120 and system memory, for example in response to cache fill requests and data evictions. In some embodiments, multiple instances of memory interface 130 may be implemented, with each instance configured to control a respective bank of system memory. Memory interface 130 may be configured to interface to any suitable type of system memory, such as Fully Buffered Dual Inline Memory Module (FB-DIMM), Double Data Rate or Double Data Rate 2, 3, or 4 Synchronous Dynamic Random Access Memory (DDR/DDR2/DDR3/DDR4 SDRAM), or Rambus® DRAM (RDRAM®), for example. In some embodiments, memory interface 130 may be configured to support interfacing to multiple different types of system memory.

In the illustrated embodiment, processor 10 may also be configured to receive data from sources other than system memory. System interconnect 125 may be configured to provide a central interface for such sources to exchange data with cores 100, L2 caches 105, and/or L3 cache 120. In some embodiments, system interconnect 125 may be configured to coordinate Direct Memory Access (DMA) transfers of data to and from system memory. For example, via memory interface 130, system interconnect 125 may coordinate DMA transfers between system memory and a network device attached via network interface 160, or between system memory and a peripheral device attached via peripheral interface 150.

Processor 10 may be configured for use in a multiprocessor environment with other instances of processor 10 or other compatible processors. In the illustrated embodiment, coherent processor interface(s) 140 may be configured to implement high-bandwidth, direct chip-to-chip communication between different processors in a manner that preserves memory coherence among the various processors (e.g., according to a coherence protocol that governs memory transactions).

Peripheral interface 150 may be configured to coordinate data transfer between processor 10 and one or more peripheral devices. Such peripheral devices may include, for example and without limitation, storage devices (e.g., magnetic or optical media-based storage devices including hard drives, tape drives, CD drives, DVD drives, etc.), display devices (e.g., graphics subsystems), multimedia devices (e.g., audio processing subsystems), or any other suitable type of peripheral device. In one embodiment, peripheral interface 150 may implement one or more instances of a standard peripheral interface. For example, one embodiment of peripheral interface 150 may implement the Peripheral Component Interface Express (PCI Express™ or PCIe) standard according to generation 1.x, 2.0, 3.0, or another suitable variant of that standard, with any suitable number of I/O lanes. However, it is contemplated that any suitable interface standard or combination of standards may be employed. For example, in some embodiments peripheral interface 150 may be configured to implement a version of Universal Serial Bus (USB) protocol or IEEE 1394 (Firewire®) protocol in addition to or instead of PCI Express™.

Network interface 160 may be configured to coordinate data transfer between processor 10 and one or more network devices (e.g., networked computer systems or peripherals) coupled to processor 10 via a network. In one embodiment, network interface 160 may be configured to perform the data processing necessary to implement an Ethernet (IEEE 802.3) networking standard such as Gigabit Ethernet or 10-Gigabit Ethernet, for example. However, it is contemplated that any suitable networking standard may be implemented, including forthcoming standards such as 40-Gigabit Ethernet and 100-Gigabit Ethernet. In some embodiments, network interface 160 may be configured to implement other types of networking protocols, such as Fibre Channel, Fibre Channel over Ethernet (FCoE), Data Center Ethernet, Infiniband, and/or other suitable networking protocols. In some embodiments, network interface 160 may be configured to implement multiple discrete network interface ports.

### Overview of Dynamic Multithreading Processor Core

As mentioned above, in one embodiment each of cores 100 may be configured for multithreaded, out-of-order execution. More specifically, in one embodiment, each of cores 100 may be configured to perform dynamic multithreading. Generally speaking, under dynamic multithreading, the execution resources of cores 100 may be configured to efficiently process varying types of computational workloads that exhibit different performance characteristics and resource requirements. Such workloads may vary across a continuum that emphasizes different combinations of individual-thread and multiple-thread performance.

At one end of the continuum, a computational workload may include a number of independent tasks, where completing the aggregate set of tasks within certain performance criteria (e.g., an overall number of tasks per second) is a more significant factor in system performance than the rate at which any particular task is completed. For example, in certain types of server or transaction processing environments, there may be a high volume of individual client or customer requests (such as web page requests or file system accesses). In this context, individual requests may not be particularly sensitive to processor performance. For example, requests may be I/O-bound rather than processor-bound—completion of an individual request may require I/O accesses (e.g., to relatively slow memory, network, or storage devices) that dominate the overall time required to complete the request, relative to the processor effort involved. Thus, a processor that is capable of concurrently processing many such tasks (e.g., as independently executing threads) may exhibit better performance on such a workload than a processor that emphasizes the performance of only one or a small number of concurrent tasks.

At the other end of the continuum, a computational workload may include individual tasks whose performance is highly processor-sensitive. For example, a task that involves significant mathematical analysis and/or transformation (e.g., cryptography, graphics processing, scientific computing) may be more processor-bound than I/O-bound. Such tasks may benefit from processors that emphasize single-task performance, for example through speculative execution and exploitation of instruction-level parallelism.

Dynamic multithreading represents an attempt to allocate processor resources in a manner that flexibly adapts to workloads that vary along the continuum described above. In one embodiment, cores 100 may be configured to implement fine-grained multithreading, in which each core may select instructions to execute from among a pool of instructions corresponding to multiple threads, such that instructions from different threads may be scheduled to execute adjacently. For example, in a pipelined embodiment of core 100 employing fine-grained multithreading, instructions from different threads may occupy adjacent pipeline stages, such that instructions from several threads may be in various stages of execution during a given core processing cycle. Through the use of fine-grained multithreading, cores 100 may be configured to efficiently process workloads that depend more on concurrent thread processing than individual thread performance.

In one embodiment, cores 100 may also be configured to implement out-of-order processing, speculative execution, register renaming and/or other features that improve the performance of processor-dependent workloads. Moreover, cores 100 may be configured to dynamically allocate a variety of hardware resources among the threads that are actively executing at a given time, such that if fewer threads are executing, each individual thread may be able to take advantage of a greater share of the available hardware resources. This may result in increased individual thread performance when fewer threads are executing, while retaining the flexibility to support workloads that exhibit a greater number of threads that are less processor-dependent in their performance. In various embodiments, the resources of a given core 100 that may be dynamically allocated among a varying number of threads may include branch resources (e.g., branch predictor structures), load/store resources (e.g., load/store buffers and queues), instruction completion resources (e.g., reorder buffer structures and commit logic), instruction issue resources (e.g., instruction selection and scheduling structures), register rename resources (e.g., register mapping tables), and/or memory management unit resources (e.g., translation lookaside buffers, page walk resources).

One embodiment of core 100 that is configured to perform dynamic multithreading is illustrated in FIG. 2. In the illustrated embodiment, core 100 includes an instruction fetch unit (IFU) 200 that includes an instruction cache 205. IFU 200 is coupled to a memory management unit (MMU) 270, L2 interface 265, and trap logic unit (TLU) 275. IFU 200 is additionally coupled to an instruction processing pipeline that begins with a select unit 210 and proceeds in turn through a decode unit 215, a rename unit 220, a pick unit 225, and an issue unit 230. Issue unit 230 is coupled to issue instructions to any of a number of instruction execution resources: an execution unit 0 (EXU0) 235, an execution unit 1 (EXU1) 240, a load store unit (LSU) 245 that includes a data cache 250, and/or a floating-point/graphics unit (FGU) 255. These instruction execution resources are coupled to a working register file 260. Additionally, LSU 245 is coupled to L2 interface 265 and MMU 270.

In the following discussion, exemplary embodiments of each of the structures of the illustrated embodiment of core 100 are described. However, it is noted that the illustrated partitioning of resources is merely one example of how core 100 may be implemented. Alternative configurations and variations are possible and contemplated.

Instruction fetch unit 200 may be configured to provide instructions to the rest of core 100 for execution. In one embodiment, IFU 200 may be configured to select a thread to be fetched, fetch instructions from instruction cache 205 for the selected thread and buffer them for downstream processing, request data from L2 cache 105 in response to instruction cache misses, and predict the direction and target of control transfer instructions (e.g., branches). In some embodiments, IFU 200 may include a number of data structures in addition to instruction cache 205, such as an instruction translation lookaside buffer (ITLB), instruction buffers, and/or structures configured to store state that is relevant to thread selection and processing.

In one embodiment, during each execution cycle of core 100, IFU 200 may be configured to select one thread that will enter the IFU processing pipeline. Thread selection may take into account a variety of factors and conditions, some thread-specific and others IFU-specific. For example, certain instruction cache activities (e.g., cache fill), ITLB activities, or diagnostic activities may inhibit thread selection if these activities are occurring during a given execution cycle. Additionally, individual threads may be in specific states of readiness that affect their eligibility for selection. For example, a thread for which there is an outstanding instruction cache miss may not be eligible for selection until the miss is resolved. In some embodiments, those threads that are eligible to participate in thread selection may be divided into groups by priority, for example depending on the state of the thread or of the ability of the IFU pipeline to process the thread. In such embodiments, multiple levels of arbitration may be employed to perform thread selection: selection occurs first by group priority, and then within the selected group according to a suitable arbitration algorithm (e.g., a least-recently-fetched algorithm). However, it is noted that any suitable scheme for thread selection may be employed, including arbitration schemes that are more complex or simpler than those mentioned here.

Once a thread has been selected for fetching by IFU 200, instructions may actually be fetched for the selected thread. To perform the fetch, in one embodiment, IFU 200 may be configured to generate a fetch address to be supplied to instruction cache 205. In various embodiments, the fetch address may be generated as a function of a program counter associated with the selected thread, a predicted branch target address, or an address supplied in some other manner (e.g., through a test or diagnostic mode). The generated fetch address may then be applied to instruction cache 205 to determine whether there is a cache hit.

In some embodiments, accessing instruction cache 205 may include performing fetch address translation (e.g., in the case of a physically indexed and/or tagged cache), accessing a cache tag array, and comparing a retrieved cache tag to a requested tag to determine cache hit status. If there is a cache hit, IFU 200 may store the retrieved instructions within buffers for use by later stages of the instruction pipeline. If there is a cache miss, IFU 200 may coordinate retrieval of the missing cache data from L2 cache 105. In some embodiments, IFU 200 may also be configured to prefetch instructions into instruction cache 205 before the instructions are actually required to be fetched. For example, in the case of a cache miss, IFU 200 may be configured to retrieve the missing data for the requested fetch address as well as addresses that sequentially follow the requested fetch address, on the assumption that the following addresses are likely to be fetched in the near future.

In many ISAs, instruction execution proceeds sequentially according to instruction addresses (e.g., as reflected by one or more program counters). However, control transfer instructions (CTIs) such as branches, call/return instructions, or other types of instructions may cause the transfer of execution from a current fetch address to a nonsequential address. As mentioned above, IFU 200 may be configured to predict the direction and target of CTIs (or, in some embodiments, a subset of the CTIs that are defined for an ISA) in order to reduce the delays incurred by waiting until the effect of a CTI is known with certainty. In one embodiment, IFU 200 may be configured to implement a perceptron-based dynamic branch predictor, although any suitable type of branch predictor may be employed.

To implement branch prediction, IFU 200 may implement a variety of control and data structures in various embodiments, such as history registers that track prior branch history, weight tables that reflect relative weights or strengths of predictions, and/or target data structures that store fetch addresses that are predicted to be targets of a CTI. Also, in some embodiments, IFU 200 may further be configured to partially decode (or predecode) fetched instructions in order to facilitate branch prediction. A predicted fetch address for a given thread may be used as the fetch address when the given thread is selected for fetching by IFU 200. The outcome of the prediction may be validated when the CTI is actually executed (e.g., if the CTI is a conditional instruction, or if the CTI itself is in the path of another predicted CTI). If the prediction was incorrect, instructions along the predicted path that were fetched and issued may be cancelled.

Through the operations discussed above, IFU 200 may be configured to fetch and maintain a buffered pool of instructions from one or multiple threads, to be fed into the remainder of the instruction pipeline for execution. Generally speaking, select unit 210 may be configured to select and schedule threads for execution. In one embodiment, during any given execution cycle of core 100, select unit 210 may be configured to select up to one ready thread out of the maximum number of threads concurrently supported by core 100 (e.g., 8 threads), and may select up to two instructions from the selected thread for decoding by decode unit 215, although in other embodiments, a differing number of threads and instructions may be selected. In various embodiments, different conditions may affect whether a thread is ready for selection by select unit 210, such as branch mispredictions, unavailable instructions, or other conditions. To ensure fairness in thread selection, some embodiments of select unit 210 may employ arbitration among ready threads (e.g. a least-recently-used algorithm).

The particular instructions that are selected for decode by select unit 210 may be subject to the decode restrictions of decode unit 215; thus, in any given cycle, fewer than the maximum possible number of instructions may be selected. Additionally, in some embodiments, select unit 210 may be configured to allocate certain execution resources of core 100 to the selected instructions, so that the allocated resources will not be used for the benefit of another instruction until they are released. For example, select unit 210 may allocate resource tags for entries of a reorder buffer, load/store buffers, or other downstream resources that may be utilized during instruction execution.

Generally, decode unit 215 may be configured to prepare the instructions selected by select unit 210 for further processing. Decode unit 215 may be configured to identify the particular nature of an instruction (e.g., as specified by its opcode) and to determine the source and sink (i.e., destination) registers encoded in an instruction, if any. In some embodiments, decode unit 215 may be configured to detect certain dependencies among instructions, to remap architectural registers to a flat register space, and/or to convert certain complex instructions to two or more simpler instructions for execution. Additionally, in some embodiments, decode unit 215 may be configured to assign instructions to slots for subsequent scheduling. In one embodiment, two slots 0-1 may be defined, where slot 0 includes instructions executable in load/store unit 245 or execution units 235-240, and where slot 1 includes instructions executable in execution units 235-240, floating-point/graphics unit 255, and any branch instructions. However, in other embodiments, other numbers of slots and types of slot assignments may be employed, or slots may be omitted entirely.

Register renaming may facilitate the elimination of certain dependencies between instructions (e.g., write-after-read or “false” dependencies), which may in turn prevent unnecessary serialization of instruction execution. In one embodiment, rename unit 220 may be configured to rename the logical (i.e., architected) destination registers specified by instructions by mapping them to a physical register space, resolving false dependencies in the process. In some embodiments, rename unit 220 may maintain mapping tables that reflect the relationship between logical registers and the physical registers to which they are mapped.

Once decoded and renamed, instructions may be ready to be scheduled for execution. In the illustrated embodiment, pick unit 225 may be configured to pick instructions that are ready for execution and send the picked instructions to issue unit 230. In one embodiment, pick unit 225 may be configured to maintain a pick queue that stores a number of decoded and renamed instructions as well as information about the relative age and status of the stored instructions. During each execution cycle, this embodiment of pick unit 225 may pick up to one instruction per slot. For example, taking instruction dependency and age information into account, for a given slot, pick unit 225 may be configured to pick the oldest instruction for the given slot that is ready to execute.

In some embodiments, pick unit 225 may be configured to support load/store speculation by retaining speculative load/store instructions (and, in some instances, their dependent instructions) after they have been picked. This may facilitate replaying of instructions in the event of load/store misspeculation. Additionally, in some embodiments, pick unit 225 may be configured to deliberately insert “holes” into the pipeline through the use of stalls, e.g., in order to manage downstream pipeline hazards such as synchronization of certain load/store or long-latency FGU instructions.

Issue unit 230 may be configured to provide instruction sources and data to the various execution units for picked instructions. In one embodiment, issue unit 230 may be configured to read source operands from the appropriate source, which may vary depending upon the state of the pipeline. For example, if a source operand depends on a prior instruction that is still in the execution pipeline, the operand may be bypassed directly from the appropriate execution unit result bus. Results may also be sourced from register files representing architectural (i.e., user-visible) as well as non-architectural state. In the illustrated embodiment, core 100 includes a working register file 260 that may be configured to store instruction results (e.g., integer results, floating-point results, and/or condition code results) that have not yet been committed to architectural state, and which may serve as the source for certain operands. The various execution units may also maintain architectural integer, floating-point, and condition code state from which operands may be sourced.

Instructions issued from issue unit 230 may proceed to one or more of the illustrated execution units for execution. In one embodiment, each of EXU0 235 and EXU1 240 may be similarly or identically configured to execute certain integer-type instructions defined in the implemented ISA, such as arithmetic, logical, and shift instructions. In the illustrated embodiment, EXU0 235 may be configured to execute integer instructions issued from slot 0, and may also perform address calculation and for load/store instructions executed by LSU 245. EXU1 240 may be configured to execute integer instructions issued from slot 1, as well as branch instructions. In one embodiment, FGU instructions and multicycle integer instructions may be processed as slot 1 instructions that pass through the EXU1 240 pipeline, although some of these instructions may actually execute in other functional units.

In some embodiments, architectural and non-architectural register files may be physically implemented within or near execution units 235-240. It is contemplated that in some embodiments, core 100 may include more or fewer than two integer execution units, and the execution units may or may not be symmetric in functionality. Also, in some embodiments execution units 235-240 may not be bound to specific issue slots, or may be differently bound than just described.

Load store unit 245 may be configured to process data memory references, such as integer and floating-point load and store instructions and other types of memory reference instructions. LSU 245 may include a data cache 250 as well as logic configured to detect data cache misses and to responsively request data from L2 cache 105. In one embodiment, data cache 250 may be configured as a set-associative, write-through cache in which all stores are written to L2 cache 105 regardless of whether they hit in data cache 250. As noted above, the actual computation of addresses for load/store instructions may take place within one of the integer execution units, though in other embodiments, LSU 245 may implement dedicated address generation logic. In some embodiments, LSU 245 may implement an adaptive, history-dependent hardware prefetcher configured to predict and prefetch data that is likely to be used in the future, in order to increase the likelihood that such data will be resident in data cache 250 when it is needed.

In various embodiments, LSU 245 may implement a variety of structures configured to facilitate memory operations. For example, LSU 245 may implement a data TLB to cache virtual data address translations, as well as load and store buffers configured to store issued but not-yet-committed load and store instructions for the purposes of coherency snooping and dependency checking LSU 245 may include a miss buffer configured to store outstanding loads and stores that cannot yet complete, for example due to cache misses. In one embodiment, LSU 245 may implement a store queue configured to store address and data information for stores that have committed, in order to facilitate load dependency checking LSU 245 may also include hardware configured to support atomic load-store instructions, memory-related exception detection, and read and write access to special-purpose registers (e.g., control registers).

Floating point/graphics unit 255 may be configured to execute and provide results for certain floating-point and graphics-oriented instructions defined in the implemented ISA. For example, in one embodiment FGU 255 may implement single- and double-precision floating-point arithmetic instructions compliant with the IEEE 754-1985 floating-point standard, such as add, subtract, multiply, divide, and certain transcendental functions. Also, in one embodiment FGU 255 may implement partitioned-arithmetic and graphics-oriented instructions defined by a version of the SPARC® Visual Instruction Set (VIS™) architecture, such as VIS™ 2.0 or VIS™ 3.0. In some embodiments, FGU 255 may implement fused and unfused floating-point multiply-add instructions. Additionally, in one embodiment FGU 255 may implement certain integer instructions such as integer multiply, divide, and population count instructions. Depending on the implementation of FGU 255, some instructions (e.g., some transcendental or extended-precision instructions) or instruction operand or result scenarios (e.g., certain denormal operands or expected results) may be trapped and handled or emulated by software.

In one embodiment, FGU 255 may implement separate execution pipelines for floating-point add/multiply, divide/square root, and graphics operations, while in other embodiments the instructions implemented by FGU 255 may be differently partitioned. In various embodiments, instructions implemented by FGU 255 may be fully pipelined (i.e., FGU 255 may be capable of starting one new instruction per execution cycle), partially pipelined, or may block issue until complete, depending on the instruction type. For example, in one embodiment floating-point add and multiply operations may be fully pipelined, while floating-point divide operations may block other divide/square root operations until completed.

Embodiments of FGU 255 may also be configured to implement hardware cryptographic support. For example, FGU 255 may include logic configured to support encryption/decryption algorithms such as Advanced Encryption Standard (AES), Data Encryption Standard/Triple Data Encryption Standard (DES/3DES), the Kasumi block cipher algorithm, and/or the Camellia block cipher algorithm. FGU 255 may also include logic to implement hash or checksum algorithms such as Secure Hash Algorithm (SHA-1, SHA-256, SHA-384, SHA-512), or Message Digest 5 (MD5). FGU 255 may also be configured to implement modular arithmetic such as modular multiplication, reduction and exponentiation, as well as various types of Galois field operations. In one embodiment, FGU 255 may be configured to utilize the floating-point multiplier array for modular multiplication. In various embodiments, FGU 255 may implement several of the aforementioned algorithms as well as other algorithms not specifically described.

The various cryptographic and modular arithmetic operations provided by FGU 255 may be invoked in different ways for different embodiments. In one embodiment, these features may be implemented via a discrete coprocessor that may be indirectly programmed by software, for example by using a control word queue defined through the use of special registers or memory-mapped registers. In another embodiment, the ISA may be augmented with specific instructions that may allow software to directly perform these operations.

As previously described, instruction and data memory accesses may involve translating virtual addresses to physical addresses. In one embodiment, such translation may occur on a page level of granularity, where a certain number of address bits comprise an offset into a given page of addresses, and the remaining address bits comprise a page number. For example, in an embodiment employing 4 MB pages, a 64-bit virtual address and a 40-bit physical address, 22 address bits (corresponding to 4 MB of address space, and typically the least significant address bits) may constitute the page offset. The remaining 42 bits of the virtual address may correspond to the virtual page number of that address, and the remaining 18 bits of the physical address may correspond to the physical page number of that address. In such an embodiment, virtual to physical address translation may occur by mapping a virtual page number to a particular physical page number, leaving the page offset unmodified.

Such translation mappings may be stored in an ITLB or a DTLB for rapid translation of virtual addresses during lookup of instruction cache 205 or data cache 250. In the event no translation for a given virtual page number is found in the appropriate TLB, memory management unit 270 may be configured to provide a translation. In one embodiment, MMU 270 may be configured to manage one or more translation tables stored in system memory and to traverse such tables (which in some embodiments may be hierarchically organized) in response to a request for an address translation, such as from an ITLB or DTLB miss. (Such a traversal may also be referred to as a page table walk or a hardware table walk.) In some embodiments, if MMU 270 is unable to derive a valid address translation, for example if one of the memory pages including a necessary page table is not resident in physical memory (i.e., a page miss), MMU 270 may be configured to generate a trap to allow a memory management software routine to handle the translation. It is contemplated that in various embodiments, any desirable page size may be employed. Further, in some embodiments multiple page sizes may be concurrently supported.

As noted above, several functional units in the illustrated embodiment of core 100 may be configured to generate off-core memory requests. For example, IFU 200 and LSU 245 each may generate access requests to L2 cache 105 in response to their respective cache misses. Additionally, MMU 270 may be configured to generate memory requests, for example while executing a page table walk. In the illustrated embodiment, L2 interface 265 may be configured to provide a centralized interface to the L2 cache 105 associated with a particular core 100, on behalf of the various functional units that may generate L2 accesses. In one embodiment, L2 interface 265 may be configured to maintain queues of pending L2 requests and to arbitrate among pending requests to determine which request or requests may be conveyed to L2 cache 105 during a given execution cycle. For example, L2 interface 265 may implement a least-recently-used or other algorithm to arbitrate among L2 requestors. In one embodiment, L2 interface 265 may also be configured to receive data returned from L2 cache 105, and to direct such data to the appropriate functional unit (e.g., to data cache 250 for a data cache fill due to miss).

During the course of operation of some embodiments of core 100, exceptional events may occur. For example, an instruction from a given thread that is selected for execution by select unit 210 may not be a valid instruction for the ISA implemented by core 100 (e.g., the instruction may have an illegal opcode), a floating-point instruction may produce a result that requires further processing in software, MMU 270 may not be able to complete a page table walk due to a page miss, a hardware error (such as uncorrectable data corruption in a cache or register file) may be detected, or any of numerous other possible architecturally-defined or implementation-specific exceptional events may occur. In one embodiment, trap logic unit 275 may be configured to manage the handling of such events. For example, TLU 275 may be configured to receive notification of an exceptional event occurring during execution of a particular thread, and to cause execution control of that thread to vector to a supervisor-mode software handler (i.e., a trap handler) corresponding to the detected event. Such handlers may include, for example, an illegal opcode trap handler configured to return an error status indication to an application associated with the trapping thread and possibly terminate the application, a floating-point trap handler configured to fix up an inexact result, etc.

In one embodiment, TLU 275 may be configured to flush all instructions from the trapping thread from any stage of processing within core 100, without disrupting the execution of other, non-trapping threads. In some embodiments, when a specific instruction from a given thread causes a trap (as opposed to a trap-causing condition independent of instruction execution, such as a hardware interrupt request), TLU 275 may implement such traps as precise traps. That is, TLU 275 may ensure that all instructions from the given thread that occur before the trapping instruction (in program order) complete and update architectural state, while no instructions from the given thread that occur after the trapping instruction (in program) order complete or update architectural state.

Additionally, in the absence of exceptions or trap requests, TLU 275 may be configured to initiate and monitor the commitment of working results to architectural state. For example, TLU 275 may include a reorder buffer (ROB) that coordinates transfer of speculative results into architectural state. TLU 275 may also be configured to coordinate thread flushing that results from branch misprediction. For instructions that are not flushed or otherwise cancelled due to mispredictions or exceptions, instruction processing may end when instruction results have been committed.

In various embodiments, any of the units illustrated in FIG. 2 may be implemented as one or more pipeline stages, to form an instruction execution pipeline that begins when thread fetching occurs in IFU 200 and ends with result commitment by TLU 275. Depending on the manner in which the functionality of the various units of FIG. 2 is partitioned and implemented, different units may require different numbers of cycles to complete their portion of instruction processing. In some instances, certain units (e.g., FGU 255) may require a variable number of cycles to complete certain types of operations.

Through the use of dynamic multithreading, in some instances, it is possible for each stage of the instruction pipeline of core 100 to hold an instruction from a different thread in a different stage of execution, in contrast to conventional processor implementations that typically require a pipeline flush when switching between threads or processes. In some embodiments, flushes and stalls due to resource conflicts or other scheduling hazards may cause some pipeline stages to have no instruction during a given cycle. However, in the fine-grained multithreaded processor implementation employed by the illustrated embodiment of core 100, such flushes and stalls may be directed to a single thread in the pipeline, leaving other threads undisturbed. Additionally, even if one thread being processed by core 100 stalls for a significant length of time (for example, due to an L2 cache miss), instructions from another thread may be readily selected for issue, thus increasing overall thread processing throughput.

As described previously, however, the various resources of core 100 that support fine-grained multithreaded execution may also be dynamically reallocated to improve the performance of workloads having fewer numbers of threads. Under these circumstances, some threads may be allocated a larger share of execution resources while other threads are allocated correspondingly fewer resources. Even when fewer threads are sharing comparatively larger shares of execution resources, however, core 100 may still exhibit the flexible, thread-specific flush and stall behavior described above.

### Improving Scouting Effectiveness Using Non-Committing Store Instructions

As noted above, instructions executed during scouting are not permitted to update architectural state, and thus are not committed. As a result, normal (i.e., committing) store instructions cannot be executed during scouting. Eliminating store instructions, however, can cause a scouting thread to execute inaccurate prefetches, thereby limiting the effectiveness of scouting. To improve the effectiveness of scouting, processor 10 may support execution of a non-committing store instruction.

Turning now to FIG. 3A, one embodiment of a memory access unit (MAU) 300 (which may be included within a core 100 of processor 10 in some embodiments) configured to perform store instructions including a non-committing store instruction is shown. As will be described below, in various embodiments, MAU 300 is configured to receive memory access instructions and initiate memory access operations specified by the received instructions. In one embodiment, MAU 300 is configured to perform an instance of a committing store instruction by storing information about that instance in a store buffer until the information can be written to a cache upon commitment of that instance. (The term “instance” is used herein to distinguish between referring to an instruction (e.g., as defined within an ISA) and to a specific occurrence of that instruction within a sequence of instructions. For example, multiple “instances” of the same instruction may occur in an instruction sequence, where each instance may include the same opcode but different operands. As used herein, a “committing store instance” is an instance of a committing store instruction. As used herein, a “non-committing store instance” is an instance of a non-committing store instruction. As used herein, a “store instance” may refer to either a committing store instance or a non-committing store instance.) In one embodiment, MAU 300 is configured to perform an instance of a non-committing store instruction by storing information about that instance in a store buffer without committing that instance and writing its information to a cache. Thus, the stored information maybe available for use by a subsequently issued instance of a load instruction even though architectural state is not updated. (As used herein, a “load instance” is an instance of a load instruction.)

In the illustrated embodiment, MAU 300 includes control unit 310, store buffer 320, and data cache 330. In other embodiments, MAU 300 may include additional (or fewer) structures, such as hardware configured to support coherency snooping and dependency checking, atomic load-store instructions, memory-related exception detection, read and write access to special-purpose registers (e.g., control registers), etc. In some embodiments, MAU 300 may correspond to LSU 245 or implement features of LSU 245 described above.

Control unit 310, in one embodiment, is representative of logic that is configured to coordinate the operation of MAU 300 during the performance of a memory access instruction, such as a store instruction. In various embodiments, control unit 310 is configured to coordinate the storing of data in store buffer 320 and in data cache 330. As will be described below, control unit 310, in various embodiments, is configured to coordinate the performance of committing and non-committing store instructions.

In the illustrated embodiment, control unit 310 is configured to receive an opcode (e.g., from a previous pipeline stage) indicating that a store operation is to be performed. In one embodiment, the opcode of a store instruction specifies whether the store instruction is a committing or non-committing store instruction. For example, separate opcodes may be defined within the ISA of processor 10 for a committing store instruction and a non-committing instruction. In one embodiment, control unit 310 is configured to use the store opcode to directly decode a store instruction from opcode bits sent from upstream pipeline stages. In another embodiment, the store opcode may be an already-decoded or partially-decoded signal indicative of the occurrence of a committing store instruction or a non-committing store instruction.

Similarly, control unit 310 may be configured to receive one or more store operands corresponding to the store instruction. In one embodiment, the received store operands include a value to be stored. In some embodiments, issue unit 230 may be configured to fetch the value from register files representing architectural (i.e., user-visible) as well as non-architectural state. Alternatively, in some embodiments, issue unit 230 may be configured to receive the value from an execution bypass bus. In one embodiment, the received store operands include a memory address specifying where the value is to be stored. In one embodiment, the memory address is an immediate address specified by the instance of that instruction. In another embodiment, the memory address is an effective address that is computed from a base and an offset. In some embodiments, MAU 300 may be configured to compute the effective address. In other embodiments, other execution units (e.g., execution units 235 and 240) may be configured to compute the effective address. In one embodiment, the memory address may be a virtual address that can be converted to a corresponding physical address. As will be described below, control unit 310, in various embodiments, is configured to store one or more of the received operands in store buffer 320 and/or data cache 330.

In one embodiment, control unit 310 is configured to receive a commit indication specifying that an instance of an issued store instruction is to be committed, and is further configured to coordinate the writing of the results of the committed instance to data cache 330. For example, if a given instance of a store instruction was executed speculatively based on a predicted branch outcome, control unit 310 may receive a commit indication once the outcome of the branch has been determined to have been predicted correctly (meaning that the instance has been determined to be non-speculative). In the illustrated embodiment, control unit 310 is configured to receive the commit indication from TLU 275. In other embodiments in which trap handling and commitment management are handled by separate units, control unit 310 may be configured to receive the commit indication from a separate commit unit. As will be described below, in one embodiment, TLU 275 is configured to provide a commit indication for an instance of a committing store instruction but not for an instance of a non-committing instruction.

Store buffer 320, in one embodiment, is configured to store information for issued but not-yet-committed store instructions. In some embodiments, store buffer 320 includes a plurality of entries to store information about a plurality of store instances. As will be described below in conjunction with FIG. 4, such information may include a value to be stored, a memory address for storing the value, an indication of whether that instance has been committed yet or not, etc. In one embodiment, when control unit 310 receives a commit indication for a given committing store instance, control unit 310 is configured to cause the entry of that instance to be retrieved from store buffer 320 and a corresponding entry to be written to data cache 330. In some embodiment, control unit 310 may be configured to initiate storing information in data cache 330 by setting a bit in an entry of store buffer 320 for a given store instance once it is committed. In one embodiment, if data from a store buffer entry has been written to cache 330, store buffer 320 may deallocate that entry to free it for a subsequent store instance. In some embodiments, store buffer 320 is also configured to deallocate an entry if all entries of buffer 320 have been allocated and that entry is the oldest allocated entry. Entries may remain in store buffer 320 (necessitating, in some embodiments, eventual deallocation) for various reasons, such as when an instruction instance is never committed (e.g., due to a mispredicted branch) or an instruction instance of a non-committing store instance as described herein.

As will be described below in conjunction with FIG. 3B, MAU 300, in various embodiments, is configured to retrieve information about a given store instance from store buffer 320 in response to MAU 300 receiving a load instance that specifies a load from the same memory address specified by the store instance. For example, store buffer 320 may store a value of a non-committing store instance in one of a plurality of entries. In response to subsequently (i.e., after initiating execution of the non-committing store instance) receiving a load instance that specifies a load from the same memory address, MAU 300 may be configured to perform the load instance by retrieving the value from store buffer 320 (note that the value is not guaranteed to reside in store buffer 320 indefinitely). In one embodiment, store buffer 320 is configured as a content addressable memory. In some embodiments, store buffer 320 may include one or more comparators configured to compare the memory address of the load instance with a memory address stored in a respective buffer entry in order to determine whether that entry includes pertinent store information. Store buffer 320 is described in further detail below in conjunction with FIG. 4.

Data cache 330, in one embodiment, is configured to store information for store instances that have been committed and to not store information for non-committing store instances. In one embodiment, data cache 330 is configured as a write-through cache in which stores are written to a higher-level cache (e.g., L2 cache 105) regardless of whether they hit in data cache 330. In another embodiment, data cache 330 is configured as a write-back cache in which stores are written to a higher-level cache only upon eviction from data cache 330. In one embodiment, data cache 330 corresponds to data cache 250 described above. Although data cache 330 is shown as being within MAU 300, cache 330 may be located elsewhere in other embodiments.

When MAU 300 performs a committing store instance, control unit 310, in one embodiment, is configured to initiate the performance of that instance in response to receiving a) an opcode specifying a committing store instruction is to be performed and b) a corresponding set of operands. In one embodiment, control unit 310 begins the performing of the instruction instance by instructing store buffer 320 to store information about that instance—e.g. the value to be stored and the memory address for storing it. In one embodiment, store buffer 320 continues to store this information until TLU 275 provides an indication that the instance is to be committed. Then, control unit 310, in one embodiment, causes information about the instance to be removed from store buffer 320 and written to cache 330. In one embodiment, if cache 330 is configured as a write-through cache, the information written to cache 330 may also be written to higher-level caches (e.g., L2 and L3 caches) as well. In another embodiment, if cache 330 is configured as a write-back cache, the information may be written to higher-level caches upon being evicted from cache 330. If, at any point, execution begins of a load instance that specifies a load from the same address as specified by the committing store instance, the data of that store instance may be retrieved from store buffer 320 or data cache 330 to perform the subsequent load instance.

When MAU 300 performs a non-committing store instance, control unit 310, in one embodiment, is configured to initiate the performing of that instance in response to receiving a) an opcode specifying that a non-committing store instruction is to be performed and b) a corresponding set of operands. In one embodiment, control unit 310 begins the performance by instructing store buffer 320 to store information about that instance. Since a non-committing store instance is never committed, control unit 310, in one embodiment, does not receive a corresponding commit indication from TLU 275 and thus, does not cause information about that instance to stored in cache 330. As a result, store buffer 320, in one embodiment, continues to store information about that instance until the entry storing the information is deallocated—e.g., because it becomes the oldest in store buffer 320 when all entries are allocate (i.e., store buffer 320 is full). If, at any point, execution begins of a load instance that specifies a load from the same address as specified by the non-committing store instance, the data of that store instance may be retrieved from store buffer 320 to perform the subsequent load instance if the entry storing the data has not been deallocated yet. One embodiment of a method for executing a non-committing store instruction is described in conjunction with FIG. 6 below.

In the illustrated embodiment, MAU 300 is shown as being configured to perform store instructions. In some embodiments MAU 300 is also configured to perform load instructions (e.g., as described below with reference to FIG. 3B). In other embodiments, load instructions and store instructions may be performed by separate units.

Turning now to FIG. 3B, an embodiment of MAU 300 that is configured to perform load instructions is depicted. As will be described below, in various embodiments, MAU 300 may perform load instances by retrieving data from store buffer 320 or data cache 330. In the illustrated embodiment, MAU 300 includes control unit 310, store buffer 320, and data cache 330. In various embodiments, these units may implement any of the features described above with reference to FIG. 3A.

Control unit 310, in one embodiment, is configured to coordinate the performance of a load instance by MAU 300. In the illustrated embodiment, control unit 310 is configured to receive a load opcode indicating that a load operation is to be performed. In one embodiment, control unit 310 is configured to use the load opcode to directly decode a load instance from opcode bits sent from upstream pipeline stages. In another embodiment, the load opcode may be an already-decoded or partially-decoded signal indicative of the occurrence of a load instruction. In the illustrated embodiment, control unit 310 is also configured to receive one or more load operands, such as a memory address from which data is to be loaded. In various embodiments, the memory address may be any of the forms described above with respect to the store instruction.

When MAU 300 performs a load instance, control unit 310, in one embodiment, initiates performance of the load instance by providing the memory address of the load to store buffer 320 to determine whether any entries in store buffer 320 includes store information associated with the memory address—e.g., information about a previously issued store instance that specifies a store of a value to the same memory address. In one embodiment, store buffer 320 may be configured to identify entries that store relevant information by performing a comparison of the memory address of the load instance with memory addresses stored in store buffer entries. In one embodiment, if a store buffer entry includes information associated with the memory address, the corresponding value (i.e., the value that is to be stored by the store instance) is retrieved from store buffer 320 for performance of the load instance. For example, in the illustrated embodiment, this value may be retrieved and loaded into working register file 260. In some embodiments, if multiple store buffer entries include store information associated with the memory address (i.e., store information about multiple issued store instances that each specify a store of value to the same memory address), the value stored in the youngest entry (i.e., the entry that was most recently allocated) may be used to perform the load instance.

If store buffer 320 does not include any entries storing information associated with the memory address, control unit 310, in one embodiment, is configured to provide the memory address to data cache 330 to determine whether the memory address hits in cache 330—i.e., cache 330 stores a value for that memory address. (In some embodiments, control unit 310 may provide the memory address of the load instance to both buffer 320 and cache 330 in parallel.) In one embodiment, if the memory address hits in cache 330, the value stored in cache 330 is used to perform the load instance. If, however, the memory address is not found, cache 330 may signal a cache miss and a corresponding data request may be sent to higher-level caches in various embodiments. If processor 10 is performing scouting, this data request may cause the pre-fetching of data.

Turning now to FIG. 4, one embodiment of store buffer 320 is depicted. In the illustrated embodiment, store buffer 320 includes a plurality of entries 410 for storing information about a plurality of store instances. As shown, each entry 410 includes a commit bit 412, a memory address 414, and a value 416. In some embodiments, each entry 410 may include other arrangements of information. For example, in one embodiment, an entry 410 may include a thread identifier that specifies the thread that includes the store instance.

Commit bit 412, in one embodiment, is a value indicative of whether a store instance is committed or is being committed. In some embodiments, control unit 310 is configured to set commit bit 412 in response to receiving a commit indication for that instance. In one embodiment, once commit bit 412 is set, value 416 is written from store buffer 320 to cache 330.

Memory address 414, in one embodiment, is a value specifying the memory location to which value 416 is to be stored. As described above, in some embodiments, memory address 414 may be an immediate address. In other embodiments, memory address 414 may be an effective address. In various embodiments, memory address 414 may be a virtual address.

Value 416, in one embodiment, is a set of data to be stored. In various embodiments, value 416 may an integer value, floating point value, Boolean value, or any other suitable arrangement of data. As described above, value 416 may be used by a subsequently performed load instance.

In one embodiment, store buffer 320 is configured to arrange entries 410 based on the age of the entries (i.e., the time since being allocated) and to maintain a pointer 420 that identifies the youngest (or oldest entry). In some embodiments, store buffer 320 may be arranged as a circular buffer where store buffer 320 maintains a first pointer 420 that specifies the next entry to be allocated and a second pointer that specifies the oldest entry in buffer 320. As entries 410 are allocated, the first pointer 420 is advanced to subsequent entries 410. As entries 410 are deallocated, the second pointer 420 is advanced. If the first pointer 420 overlaps the second pointer 420, then store buffer 320 is full and entries 410 may need to be deallocated. In various embodiments, store buffer 320 may use other criteria for determining the age of entries 410.

By storing information about non-committing store instances in a store buffer, processor 10 can more effectively perform scouting because the load instances that have the same memory addresses can receive correct data and thus cause more accurate prefetching. Store buffers, however, have a limited capacity that is typically smaller than other storage mechanisms such as caches. In the following discussion, an embodiment of a memory access unit that is configured to store information about non-committing store instances in a data cache without committing those instances is described.

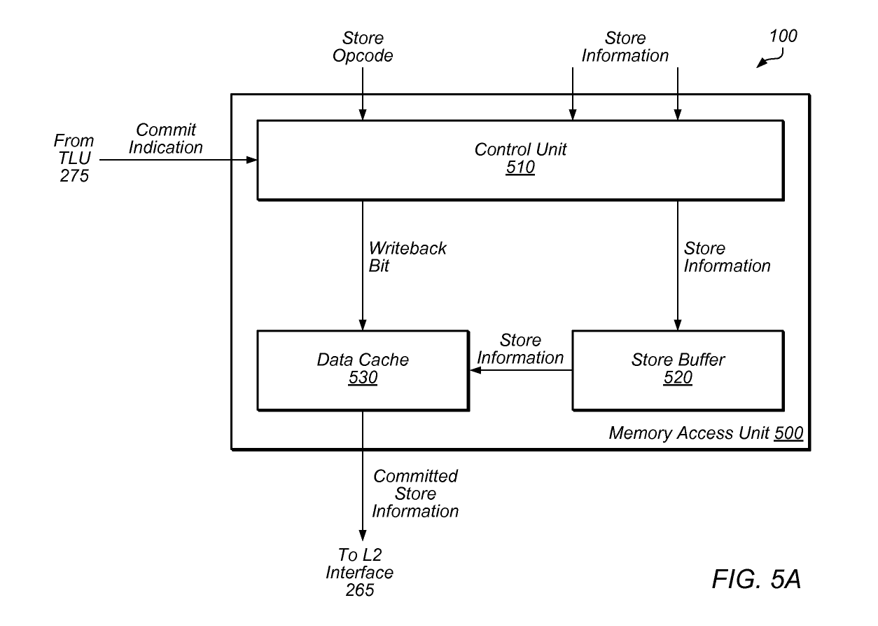

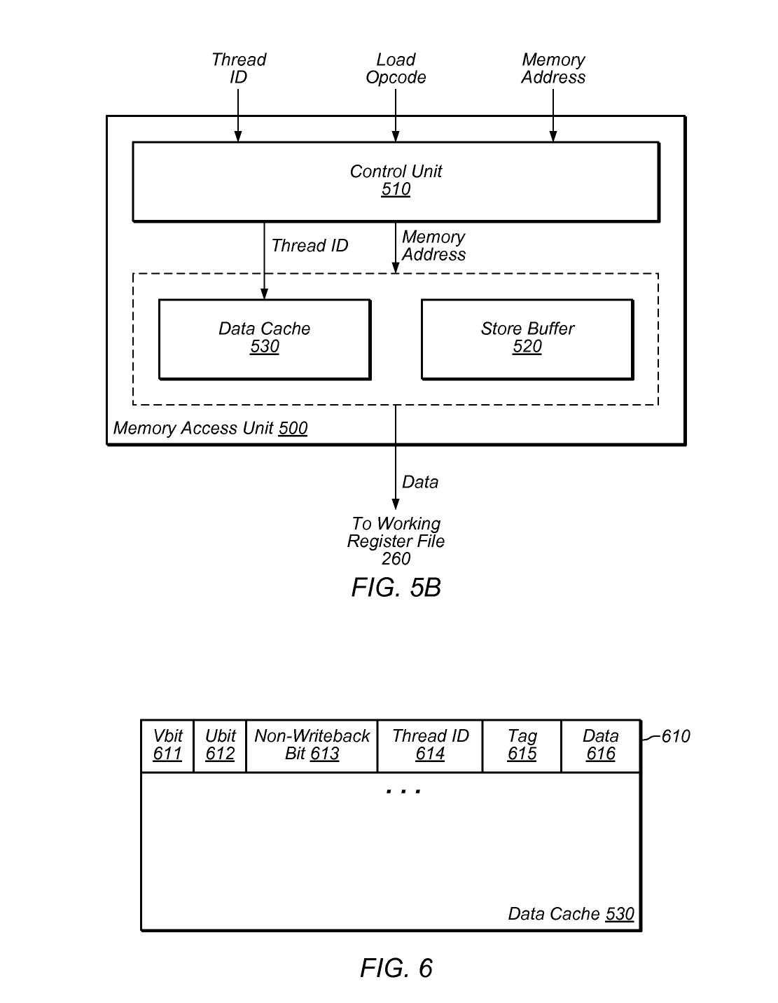

Turning now to FIG. 5A, another embodiment of a memory access unit (MAU) 500 (which may be included within a core 100 of processor 10 in some embodiments) configured to perform store instructions including a non-committing store instruction is shown. In the illustrated embodiment, MAU 500 includes control unit 510, store buffer 520, and data cache 530. In other embodiments, MAU 500 may include additional (or fewer) structures, as is desired. In some embodiments, MAU 500 may correspond to LSU 245 or implement features of LSU 245.

Control unit 510, in one embodiment, is representative of logic that is configured to coordinate the operation of MAU 500 during the performance of memory access instructions including committing and non-committing store instructions. In various embodiments, control unit 510 is configured to coordinate the storing of data in store buffer 520 and data cache 530. In one embodiment, control unit 510 is configured to receive a store opcode and one or more store operands. In some embodiments, the one or more store operands may include a value to be stored and a memory address such as described above. In one embodiment, the one or more store operands include a thread identifier that specifies the thread of the store instance.

In the illustrated embodiment, control unit 510 is configured to receive a commit indication specifying that a store instance is to be committed. As described above, in one embodiment, TLU 275 is configured to provide the commit indication for an issued committing store instance upon determining that the instance is non-speculative. In some embodiments, TLU 275 is configured to not provide the commit indication for an issued non-committing store instance.

Store buffer 520, in one embodiment, is configured to store information for issued but not-yet-committed store instructions. In various embodiments, the stored information may include a value to be stored and a memory address. In some embodiments, the stored information includes a thread identifier. In one embodiment, the stored information includes a commit bit specifying whether a given store instance is being committed or not. As described above, in some embodiments, control unit 510 may set this commit bit for a committing store instance to cause the stored information of that instance is to be retrieved from buffer 520 and to be written to cache 530. In one embodiment, control unit 510 sets the commit bit when it receives a commit indication from TLU 275. In some embodiments, control unit 510 may be configured to cause store information of a non-committing store instance to be retrieved from buffer 520 and written to cache 530 by setting the commit bit even though that instance is not be committed. In other embodiments, control unit 510 may cause information to be written to cache 530 using other techniques. In various embodiments, store buffer 520 may deallocate an entry once a corresponding entry is written to cache 530. Alternatively, store buffer 520 may also deallocate an entry if store buffer 520 is full and that entry is the oldest entry in buffer 520 as described above.

Data cache 530, in one embodiment, is configured to store information for store instances that have been committed and information for non-committing store instances that are not to be committed. For example, in various embodiments, data cache 530 may be configured to store, for a given store instance, a value, at least a portion of memory address (i.e., a tag), a thread identifier, and/or additional information such as described in FIG. 6 below. In one embodiment, data cache 530 corresponds to data cache 250 described above. Although data cache 530 is shown as being within MAU 500, cache 530 may be located elsewhere in other embodiments.

In some embodiments, data cache 530 is configured as a write-through cache. In such embodiments, if data is written to cache 530 for a committing store instance, MAU 500 maybe configured to perform a corresponding write through to higher-level caches (e.g., L2 cache 105)/memory. In one embodiment, if data is written to cache 530 for a non-committing store instance, MAU 530 does not perform a corresponding write through. In some embodiments, commit unit 510 is configured to determine whether to cause the write through for a given store instance based on its received store opcode. In other embodiments, commit unit 510 is configured to determine to whether to cause the write through for a given store instance based on indication received from TLU 275.

In other embodiments, data cache 530 is configured as a write-back cache. In such embodiments, if data cache 530 includes an entry for a committing store instance, MAU 530 may perform a write back of that entry to higher-level caches/memory when it is evicted (e.g., because some portion of the cache is full and room must be made for a new entry, because one or more cache entries are being invalidated (e.g., by a cache coherency protocol, etc.) In one embodiment, if data cache 530 includes an entry for a non-committing store instance, MAU 530 does not perform a write back of that entry when it is evicted. In one embodiment, commit unit 510 is configured to determine whether to cause the write back of the entry based on a write-back bit stored in the entry. In some embodiments, commit unit 510 is configured to set this bit based on information (e.g., another bit) stored in store buffer 520, which in turn may be set based on the received store opcode. In other embodiments, commit unit 510 is configured to set this bit based on an indication received from TLU 275. Data cache 530 may determine to evict entries using various techniques known in the art, such as evicting the oldest entry, the least used entry, etc.

In some embodiments, MAU 500 may perform a committing store instance in a similar manner as MAU 300.

When MAU 500 performs a non-committing store instance, control unit 510, in one embodiment, is configured to initiate the performance of that instance in response to receiving a) an opcode specifying that a non-committing store instruction is to be performed and b) a corresponding set of operands. In one embodiment, control unit 510 begins the performance by instructing store buffer 520 to store information about that instance. In some embodiments, control unit 510 may set a bit in store buffer 520 to cause information about that instance to be retrieved from store buffer 520 and to be stored in cache 530. In one embodiment, if cache 530 is a write-through cache, MAU 500 does not perform a write-though to higher-level caches/memory. In another embodiment, if cache 530 is a write-back cache, MAU 530 does not perform a write back to higher-level caches/memory. In some embodiments, control unit 510 may set a bit in an entry to specify whether that entry is to be written back or not. If, at any point, execution begins of a load instance that specifies a load from the same address as specified by the non-committing store instance, the data of that store instance may be retrieved from store buffer 520 or cache 530 to perform the load instance. One embodiment of a method for executing a non-committing store instruction is described in conjunction with FIG. 7 below.

In some embodiments described next, MAU 500 may also be configured to perform load instances.

Turning now to FIG. 5B, one embodiment of MAU 500 that is configured to perform load instructions is shown. In the illustrated embodiment, MAU 500 includes control unit 510, store buffer 520, and data cache 530. In various embodiments, these units may implement any of the features described above.

Control unit 510, in one embodiment, is configured to coordinate the performance of a load instance by MAU 500. In the illustrated embodiment, control unit 310 is configured to receive a load opcode indicating that a load operation is to be performed and one or more load operands. In one embodiment, control unit 510 is configured to receive a memory address from which data is to be loaded as a load operand. In some embodiments, control unit 510 is also configured to receive a thread identifier specifying the thread of the load instance as a load operand.

When MAU 500 performs a load instance, control unit 510, in one embodiment, initiates performance of the load instance by providing the memory address of the load to store buffer 520 to determine whether any entries in store buffer 520 includes store information associated with the memory address. In some embodiments, control unit 510 may also provide the thread identifier of the load instance, which may be used in the comparison as well. In one embodiment, if a store buffer entry includes information associated with the memory address and the thread identifier (i.e., the entry includes information about a store instance that is performing a write to the same memory address and that is of the same thread as the load instance and which is older in program order than the load instance), the value of the store instance is retrieved from store buffer 520 for performance of the load instance. As noted above, in some embodiments, if multiple store buffer entries are found to be associated with the memory address and the thread identifier, the value stored in the youngest entry may be used to perform the load instance.

If store buffer 520 does not include any entries storing information associated with the memory address and thread identifier, control unit 510, in one embodiment, is configured to provide the memory address and thread identifier to data cache 530 to determine whether cache 530 includes an entry associated with the memory address and thread identifier. In one embodiment, if the memory address hits in cache 530, cache 530 is configured to perform a comparison of the thread identifier of the load instance with the thread identifier stored in the cache entry. If the thread identifiers match, data cache 530 may provide the value for use in performing the load instance. If, however, the memory address does not hit in cache 530 or the thread identifiers do not match, cache 530 may signal a cache miss and a corresponding data request may be sent to higher-level caches in various embodiments. In one embodiment, cache 530 is configured to determine whether to perform a comparison of thread identifiers based on whether the memory address hits for an entry and on whether that entry includes a bit specifying that the entry is not to be written-back. Said another way, in one embodiment, cache 530 may be configured to perform a comparison of the thread identifiers only if the entry in question stores information about a non-committing store instance. Cache 530 may not perform a comparison if it determines that the entry stores information about a committing store instance. In this way, in some instances, a load instance of a scouting thread can access data of committing store instances of any thread and data of non-committing store instances, while a load instance of a non-scouting thread cannot access data of a non-committing store instance.

Turning now to FIG. 6, one embodiment of data cache 530 is depicted. In the illustrated embodiment, data cache 530 includes a plurality of entries 610 for storing information about a plurality of store instances. In some embodiments, entries 610 may also be configured to store information that was retrieved from higher-level caches or memory for load instances that caused caches misses. As shown, in one embodiment, each entry 610 includes a valid bit 611, a used bit 612, a non-write-back bit 613, a thread identifier 614, a tag 615, and a value 616. In some embodiments, each entry 610 may include different information than shown.

Valid bit 611, in one embodiment, specifies whether a particular entry 610 is to be used for memory access operations. In some embodiments, valid bit 611 is set when information is stored in that entry due to a write operation or a cache miss. Valid bit 611 may be cleared when an entry is not to be used—e.g., after memory is initialized, etc.

Used bit 612, in one embodiment, specifies whether a particular entry 610 have been used previously in performing a memory access operation. In some embodiments, used bit 612 may be cleared when a value 616 is stored to an entry.

Non-write-back bit 613, in one embodiment, specifies whether a particular entry 610 is to be written to higher-level caches/memory upon eviction—i.e., upon the entry 610 being reallocated. In one embodiment, bit 613 is cleared if that entry 610 is storing information generated by a committing store instance. In one embodiment, bit 613 is set if that entry 610 is storing information generated by a non-committing store instance.

Thread identifier 614, in one embodiment, specifies the thread of the store instance that caused value 616 to be written to an entry 610. In one embodiment, if data cache 530 receives a request for data by a load instance, data cache 530 is configured to compare thread identifier 614 with the thread identifier of the load instance before indicating that request has hit in cache 530. In some embodiments, data cache 530 may perform the comparison only if an entry 610 is storing a value 616 generated by a non-committing store instance. In one embodiment, data cache 530 determines if an entry 610 is storing such a value 616 by examining its non-write-back bit 613.

Tag 615, in one embodiment, specifies at least a portion of the memory address to which value 616 is to be stored. In one embodiment, data cache 530 compares tag 615 with a memory address specified in a received data request in order to determine whether the request hits in cache 530.

Value 616, in one embodiment, is a set of data to be stored. In various embodiments, value 616 may an integer value, floating point value, Boolean value, or other suitable data type. As described above, value 616 may be used by a subsequently performed load instance.

It is noted that cache 530 is exemplary and may be arranged differently in other embodiments. For example, in one embodiment, an entry 610 may correspond to an entire cache line that includes multiple values 616 generated by different store instances.

Turning now to FIG. 7, one embodiment of a method 700 for executing an instance of a non-committing store instruction is shown. In one embodiment, processor 10 performs method 700 upon issuing an instance of a non-committing store instruction of a scouting thread. In some embodiments, method 700 may include additional (or less) steps than shown.

In step 710, processor 10 calculates an effective address of the non-committing store instance. In one embodiment, an execution unit (e.g., execution unit 235 or unit 240) of processor 10 calculates the effective address by adding a base stored in processor 10 (e.g., in register bank 260) with an offset specified by the non-committing store instance. In other embodiments, a memory access unit (e.g., MAU 300) of processor 10 calculates the effective address. In some embodiments, step 710 may not be performed if the non-committing store instance specifies an immediate address.

In step 720, processor 10 reads data (e.g., one or more values) to be stored by the non-committing store instance. In one embodiment, an issue unit (e.g., issue unit 230) of processor 10 may be configured to read the data from register files (e.g., register file 260) representing architectural and/or non-architectural state. Alternatively, in some embodiments, the issue unit is configured to receive the value from an execution bypass bus. In other embodiments, another unit of processor 10 may be configured to read the data—e.g., MAU 300.

In step 730, processor 10 (e.g., using MAU 300) stores the effective address and data in a store buffer (e.g., store buffer 320). In some embodiments, processor 10 may store the effective address (e.g., as memory address 414) and data (e.g., as value 416) in the store buffer as each one is computed. For example, processor 10 may compute the effective address and store it before the data becomes available to be read—e.g., if the data is being generated by an instruction that takes several cycles to complete execution. As noted above, in some embodiments, the store buffer continues to store the effective address and data of the non-committing store instance in a store buffer entry until the store buffer needs to reallocate the entry for another issued store instance—e.g. because the store buffer is full. In one embodiment, while the store buffer stores the effective address and data, a memory access unit of processor 10 can perform subsequent load instances that specify the same effective address by retrieving the data from the store buffer. Once the entry storing the effective address and data is deallocated, processor 10, in various embodiments, does not update architectural state by writing the data to a cache.

By performing method 700 during scouting, processor 10 can cause a subsequently executed load instances that specify the same memory addresses as non-committing store instances to receive correct data—thus, improving the effectiveness of the scouting. As noted above, without this technique load instructions based on previous store instructions would not be as effective in causing accurate pre-fetching within a scouting thread.

Turning now to FIG. 8, another embodiment of a method 800 for executing an instance of a non-committing store instruction is shown. In one embodiment, processor 10 performs method 800 upon issuing an instance of a non-committing store instruction of a scouting thread. In some embodiments, method 800 may include additional (or fewer) steps than shown.

In step 810, processor 10 calculates an effective address of the non-committing store instance. In various embodiments, step 810 is performed in a similar manner as step 710 described above. In some embodiments, step 810 may not be performed if the non-committing store instance specifies an immediate address.

In step 820, processor 10 reads data (e.g., one or more values) to be stored by the non-committing store instance. In various embodiments, step 820 is performed in a similar manner as step 720 described above.

In step 830, processor 10 (e.g., using MAU 500) stores the effective address and data in a store buffer (e.g., store buffer 520). In some embodiments, processor 10 may store the effective address and data in the store buffer as each one is computed. In one embodiment, if processor 10 initiates execution of subsequent a load instance that specifies the same address as the non-committing store instance during step 830, a memory access unit of processor 10 can perform the load instance by retrieving the data from the store buffer.

In step 840, processor 10 (e.g., using MAU 500) stores the data read in step 820 in a data cache (e.g., data cache 530). In some embodiments, processor 10 also stores at least a portion of the memory address in the data cache. In one embodiment, processor 10 also stores a thread identifier of the non-committing store instance in the data cache. In one embodiment, processor 10 may set a bit in store buffer to cause information to be stored in the data cache. In one embodiment, if the cache is a write-through cache, processor 10 does not perform a write-though to higher-level caches/memory. In another embodiment, if the cache is a write-back cache, processor 10 does not perform a write back to higher-level caches/memory. In one embodiment, if processor 10 initiates execution of subsequent a load instance that specifies the same address as the non-committing store instance, a memory access unit of processor 10 can perform the load instance by retrieving the data from the cache. In one embodiment, the data may be visible to the load instance only if it is from the same thread—e.g., processor 10 may perform a comparison of the thread identifiers of the load instance and the non-committing store instance. Thus, in some instances, the non-committing store data stored in the cache would not be visible to another cache or another thread.

By performing method 800, processor 10 can improve the effectiveness of its scouting. In some instances, scouting performed using method 800 may be more effective then scouting performed using method 700 due to the (typically) larger capacity of a data cache than a store buffer.

Turning now to FIG. 9, one embodiment of a method 900 performed by a processor that includes a memory access unit (e.g., memory access unit 300 or 500) is shown. In one embodiment, processor 10 performs method 900 when it is executing instructions of a scouting thread.

In step 910, a memory access unit of processor 10 receives, as part of a scouting thread, an instance of a non-committing store instruction that specifies a value and a memory address to which the value is to be stored. In some embodiments, the received non-committing store instance may have been fetched (e.g., by instruction fetch unit 200), decoded (e.g., by decode unit 210), and issued (e.g., by issue unit 220). In some embodiments, the value may be retrieved from a register file (e.g., register file 260) or an execution bypass bus. In some embodiments, the memory address may be an effective address that has been computed (e.g., by one of execution units 235 or 240).

In step 920, the memory access unit performs the instance of the non-committing store instruction by storing the value in an entry of a store buffer (e.g., buffer 320 or 520) without committing it. In one embodiment, the value may remain in the store buffer entry until the entry is reallocated—e.g. because of old age. In another embodiment, the memory access unit removes the value from the store buffer and stores it in a data cache (e.g., cache 530). In one embodiment, if the data cache is a write-through data cache, the memory access unit does not perform a write through of the value to higher-level data caches/memory. In another embodiment, if the data cache is a write-back cache, the memory access unit does not perform a write back of the value to higher-level data caches/memory when the cache entry storing the value is evicted from the cache.

In step 930, the memory access unit subsequently receives an instance of a load instruction of the scouting thread that specifies a load from the memory address. In some embodiments, the load instance may be fetched, decoded, and issued in a similar manner as the non-committing store instance.

In step 940, the memory access unit performs the instance of the load instruction by retrieving the value. In some embodiments, the memory access unit retrieves the value from a store buffer. In one embodiment, the memory access unit retrieves the value from a data cache. In some embodiments, the memory access unit permits the value to be retrieved from the data cache only if the thread identifier of the load instance matches the thread identifier (e.g., thread identifier 614) of the non-committing store instance. In one embodiment, the memory access unit determines whether to perform a comparison of the thread identifiers based on whether the cache entry storing the value includes an indication (e.g., non-write-back bit 613) specifying that a write back is not to be performed for that entry.

In various embodiments, method 900 may be performed multiple times if processor 10 executes multiple non-committing store instances and multiple load instances that specify the same memory addresses as the non-committing store instances.

### Exemplary System Embodiment

As described above, in some embodiments, processor 10 of FIG. 1 may be configured to interface with a number of external devices. One embodiment of a system 1000 including processor 10 is illustrated in FIG. 10. In the illustrated embodiment, system 1000 includes an instance of processor 10, shown as processor 10a, that is coupled to a system memory 1010, a peripheral storage device 1020 and a boot device 1030. System 1000 is coupled to a network 1040, which is in turn coupled to another computer system 1050. In some embodiments, system 1000 may include more than one instance of the devices shown. In various embodiments, system 1000 may be configured as a rack-mountable server system, a standalone system, or in any other suitable form factor. In some embodiments, system 1000 may be configured as a client system rather than a server system.

In some embodiments, system 1000 may be configured as a multiprocessor system, in which processor 10a may optionally be coupled to one or more other instances of processor 10, shown in FIG. 10 as processor 10b. For example, processors 10a-b may be coupled to communicate via their respective coherent processor interfaces 160.

In various embodiments, system memory 1010 may comprise any suitable type of system memory as described above, such as FB-DIMM, DDR/DDR2/DDR3/DDR4 SDRAM, RDRAM®, flash memory, and of various types of ROM, etc. System memory 1010 may include multiple discrete banks of memory controlled by discrete memory interfaces in embodiments of processor 10 that provide multiple memory interfaces 130. Also, in some embodiments, system memory 1010 may include multiple different types of memory.

Peripheral storage device 1020, in various embodiments, may include support for magnetic, optical, or solid-state storage media such as hard drives, optical disks, nonvolatile RAM devices, etc. In some embodiments, peripheral storage device 1020 may include more complex storage devices such as disk arrays or storage area networks (SANs), which may be coupled to processor 10 via a standard Small Computer System Interface (SCSI), a Fibre Channel interface, a Firewire® (IEEE 1394) interface, or another suitable interface. Additionally, it is contemplated that in other embodiments, any other suitable peripheral devices may be coupled to processor 10, such as multimedia devices, graphics/display devices, standard input/output devices, etc. In one embodiment, peripheral storage device 1020 may be coupled to processor 10 via peripheral interface(s) 150 of FIG. 1.

As described previously, in one embodiment boot device 1030 may include a device such as an FPGA or ASIC configured to coordinate initialization and boot of processor 10, such as from a power-on reset state. Additionally, in some embodiments boot device 1030 may include a secondary computer system configured to allow access to administrative functions such as debug or test modes of processor 10.

Network 1040 may include any suitable devices, media and/or protocol for interconnecting computer systems, such as wired or wireless Ethernet, for example. In various embodiments, network 1040 may include local area networks (LANs), wide area networks (WANs), telecommunication networks, or other suitable types of networks. In some embodiments, computer system 1050 may be similar to or identical in configuration to illustrated system 1000, whereas in other embodiments, computer system 1050 may be substantially differently configured. For example, computer system 1050 may be a server system, a processor-based client system, a stateless “thin” client system, a mobile device, etc. In some embodiments, processor 10 may be configured to communicate with network 1040 via network interface(s) 160 of FIG. 1.

### Exemplary Computer-Readable Storage Medium

Turning now to FIG. 11, a computer readable storage medium 1100 is depicted. Computer-readable storage medium 1100 is one embodiment of an article of manufacture that stores instructions that are executable by system 1000 that includes processor 10. In the illustrated embodiment, computer-readable storage medium 1100 includes instances 1110A and 1110B of a non-committing store instruction and instances 1120A and 1120B of a load instruction. As shown, instances 1110A and 1120A specify the same memory address 1130A. Instances 1110B and 1120B specify the same memory address 1130B. It is noted that computer-readable storage medium 1100 is exemplary and that other arrangements of instructions than those shown are of course possible. For example, computer-readable storage medium 1100 may include other types of instructions such as committing store instructions, non-memory access instructions, etc.

Computer-readable storage medium 1100 refers to any of a variety of tangible (i.e., non-transitory) media that store program instructions and/or data used during execution. In one embodiment, computer-storage readable medium 1100 may include various portions of the memory subsystem 1710. In other embodiments, computer-readable storage medium 1100 may include storage media or memory media of a peripheral storage device 1020 such as magnetic (e.g., disk) or optical media (e.g., CD, DVD, and related technologies, etc.). Computer-readable storage medium 1100 may be either volatile or nonvolatile memory. For example, computer-readable storage medium 1100 may be (without limitation) FB-DIMM, DDR/DDR2/DDR3/DDR4 SDRAM, RDRAM®, flash memory, and of various types of ROM, etc. Note: as used herein, a computer-readable storage medium is not used to connote only a transitory medium such as a carrier wave, but rather refers to some non-transitory medium such as those enumerated above.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A processor, comprising:
a memory access unit configured to receive memory access instructions and initiate memory access operations specified by the received instructions;
wherein the memory access unit is configured to receive an instance of a non-committing store instruction within a scouting thread of the processor, wherein the non-committing store instruction specifies a value and a memory address to which the value is to be stored;
wherein the memory access unit is configured to perform the instance of the non-committing store instruction by storing the value in an entry of a store buffer without committing the instance of the non-committing store instruction, wherein the store buffer includes a plurality of entries; and
wherein the memory access unit, in response to receiving, within the scouting thread, an instance of a load instruction that specifies a load from the memory address, is configured to perform the instance of the load instruction by retrieving the value.

2. The processor of claim 1, wherein the memory access unit includes the store buffer, and wherein the memory access unit, in response to receiving the instance of the load instruction, is configured to perform the load instruction by retrieving the value from the store buffer.

3. The processor of claim 2, wherein the store buffer includes a plurality of entries in the store buffer; and
wherein the memory access unit is configured to deallocate the entry in response to determining that the entry is the oldest entry of the plurality of entries and determining that all of the plurality of entries have been allocated.

4. The processor of claim 1, wherein processor is configured to calculate an effective address of the instance of the non-committing store instruction and to read the value from a register of the processor; and
wherein the memory access unit is configured to perform the instance of the non-committing store instruction by storing the value and the effective address in the store buffer.

5. The processor of claim 1, further comprising:
a cache;
a commit unit;
wherein the commit unit is configured to send, in response to the processor executing an instance of a committing store instruction that specifies another value, a commit indication to the memory access unit to cause the memory access unit to store the value in the cache;
wherein the commit unit is configured not to send a commit indication to the memory access unit in response to the processor executing the instance of the non-committing store instruction.

6. The processor of claim 1, further comprising:
a cache;
wherein the memory access unit is configured to remove the value from the store buffer and to store the value in a cache entry, wherein the stored cache entry includes information specifying that the cache is not to perform a write back operation upon the cache entry being evicted from the cache; and
wherein the memory access unit, in response to receiving the instance of the load instruction, is configured to perform the load instruction by retrieving the value from the cache entry.

7. The processor of claim 6, wherein the memory access unit is configured to store an identifier of the scouting thread in the cache entry, and wherein the memory access unit is configured to prevent the value from being retrieved by a thread having an identifier other than the stored identifier.

8. The processor of claim 1, further comprising:
a write-through cache;
wherein the memory access unit is configured to remove the value from the store buffer and to store the value in a cache entry without performing a write through of the value; and
wherein the memory access unit, in response to receiving the instance of the load instruction, is configured to perform the load instruction by retrieving the value from the cache entry.

9. A method, comprising:
a processor executing, within a scouting thread, an instance of a non-committing store instruction, wherein the non-committing store instruction specifies a value and a memory address to which the value is to be stored, wherein executing the instance of the non-committing store instruction includes storing the value in an entry of a store buffer without committing the non-committing store instruction; and
the processor subsequently executing an instance of a load instruction of the scouting thread, wherein the load instruction specifies a load from the memory address, wherein executing the instance of the load instruction includes returning the value as a result of executing the instance of the load instruction.

10. The method of claim 9, wherein executing the instance of the non-committing store instruction includes:
the processor calculating an effective address of the instance of the non-committing store instruction;
the processor reading the value from a register of the processor;
the processor storing the value and the effective address in the store buffer, wherein the value is retrieved from the store buffer by a memory access unit of the processor.

11. The method of claim 9, wherein the store buffer includes a plurality of entries, and wherein the method further comprises:
the processor deallocating the entry in response to determining that the entry is the oldest entry of the plurality of entries and determining that all of the plurality of entries have been allocated, wherein the value is not stored in a cache of the processor after deallocating the entry.

12. The method of claim 9, further comprises:
the processor storing the value in a cache entry of a cache of the processor, wherein the value is retrieved from the cache entry; and
the processor subsequently evicting the cache entry without performing a write back of the cache entry.

13. The method of claim 12, wherein storing the value in the cache entry includes storing an indication specifying that the write back is not to be performed upon evicting the cache entry from the cache.

14. The method of claim 12, wherein storing the value in the cache entry includes storing an identifier of the scouting thread, and wherein executing the instance of the load instruction includes comparing the stored identifier with a thread identifier of the instance of the load instruction before permitting retrieving of the value.

15. The method of the claim 14, wherein storing the value in the cache entry includes storing an indication specifying whether the comparing of the stored identifier with the thread identifier of the instance of the load instruction is to be performed.

16. A computer-readable storage medium having program instructions stored thereon that are executable by a processor having a memory access unit, wherein the program instructions include:
an instance of a non-committing store instruction that specifies a first value and a first memory address to which the first value is to be stored, wherein the instance of the non-committing store instruction is executable by the processor within a scouting thread to cause the memory access unit to store the first value in a store buffer of the memory access unit without updating an architectural state of the processor; and
an instance of a load instruction that specifies a load from the first memory address, wherein the instance of the load instruction is executable by the process to cause the memory access unit to retrieve the first value.

17. The computer-readable storage medium of claim 16, wherein the instance of the load instruction is executable by the process to cause the memory access unit to retrieve the first value from the store buffer and to not write the first value to a cache of the processor.

18. The computer-readable storage medium of claim 16, wherein the instance of the load instruction is executable by the processor to cause the memory access unit to retrieve the first value from a cache entry of a cache of the processor and to not write back the value upon the cache entry being evicted from the cache.

19. The computer-readable storage medium of claim 18, wherein the instance of the load instruction is executable by the processor to cause the memory access unit to compare a thread identifier of the instance of the non-committing store instruction and a thread identifier of the instance of the load instruction before permitting retrieving of the first value.

20. The computer-readable storage medium of claim 18, wherein the program instructions include an instance of committing store instruction that specifies a second value and a second memory address, and wherein the instance of committing store instruction is executable by the processor to store the second value in the cache and to commit the second value upon eviction from the cache.
